(19) United States
(12) Patent Application Publication
(10) Pub. No.: US 2009/0118140 A1
(43) Pub. Date: May 7, 2009

(54) METHOD AND SYSTEM FOR ASSEMBLY OF MACROMOLECULES AND NANOSTRUCTURES

(76) Inventor: Vincent Suzara, Albuquerque, NM (US)

Correspondence Address: V. Gerald Grafe, esq., P.O. Box 2689, Corrales, NM, 87048, US

(21) Appl. No.: 11/936,045

(22) Filed: Nov. 6, 2007

Related U.S. Application Data
(60) Provisional application No. 60/918,144, filed on Mar. 15, 2007.
(60) Provisional application No. 60/969,154, filed on Aug. 30, 2007.

(51) Int. Cl. C40B 40/08; C40B 50/14; C40B 50/18

(52) U.S. Cl. 506/17; 506/30; 506/32

(57) ABSTRACT

A template-based system enables the assembly of macromolecules and nanostructures. The template system comprises a plurality of single strand DNA molecules which are substantially parallel, substantially inline each from one end, and substantially equally spaced apart, wherein each DNA molecule has a distinguishable length and a known sequence. The system can be used for the precise, accurate, and efficient synthesis of peptides, proteins and enzymes.

### CROSS REFERENCE TO RELATED APPLICATION

This application claims the benefit of U.S. Provisional Applications (attorney docket number 67487P(301597)), filed Mar. 15, 2007, and 60/969,154, filed Aug. 30, 2007, which are incorporated herein by reference.

### FIELD OF THE INVENTION

The present invention relates generally to synthetic methods and systems for the in-vitro template-mediated synthesis of macromolecules, e.g., polypeptides, enzymes, nanostructures, and the like.

### BACKGROUND OF THE INVENTION

Modem biotechnology has recently witnessed an explosive interest in the capacity to construct and/or assemble complex molecular structures, including polypeptides, enzymes and nanostructures, on the basis of sequence-specific or template-based systems utilizing nucleic acids as programmable blueprints. See e.g., Deng et al., “DNA-Encoded Self-Assembly of Gold Nanoparticles into One-Dimensional Arrays,” Angew. Chem. Int. Ed. 44, 3582 (2005), and U.S. Publication No. 2005/0158763, both of which are incorporated herein by reference. Such sequence-specific assemblies take advantage of Watson-Crick base pairing between complementary deoxyribonucleic acid (DNA) strands to synthesize and assemble a great variety of macromolecules and nanostructures.

These template-based systems can be used to synthesize new and improved enzymes, including, for example, cellulases, which are important enzymes in the manufacture of ethanol from plant biomass. Plant biomass, e.g., agricultural and forestry products, associated by-products and waste, municipal solid waste, and industrial waste, is the most abundant source of carbohydrate in the world due to cellulose-rich cell walls of all higher plants. Cellulose can be converted to sugars, which are ultimately fermented to ethanol by well-known methods. A major limitation in ethanol production, however, is the severe intolerance of cellulose-degrading enzymes to high-acid and high-temperature conditions typical of ethanol production processes as befitting their nature as biodegradable molecules. As such, there is a need in the art to generate alternative cellulase enzymes having improved properties, e.g., acid-resistance, heat-resistance, and greater substrate range, capable of carrying out commercial-scale processing of cellulose to sugar for use in biofuel production.

Just as with cellulases and ethanol production, there is also a great demand for other improved commercially-relevant enzymes, such as those involved in the production of food-related items (e.g., sweeteners, chocolate syrup, bakery products, alcoholic beverages, and dairy products) and in the production of non-food related items (e.g., detergents, clothing treatments, pulp and paper manufacture, and leather treatments). Template-based systems are also seen as having great potential in the construction of useful nanostructures for a variety of applications, such as, new dispersions and coatings (e.g., drug delivery systems), membranes, molecular computation, optoelectronics, bioelectronics, and molecular motors.

One limitation of template-based systems known in the art relates, in part, to their inability to precisely, accurately, and efficiently manipulate, on a molecular scale, the molecular building blocks comprising the macromolecules and nanostructures of interest such that new and useful macromolecular structures (e.g., novel or improved enzymes) and nanostructures (e.g., one-, two-, and three-dimensional arrays for use in micromechanical, microelectronic, bioelectronic and bio-sensing applications) can be developed.

Accordingly, new and improved methodologies and systems for effective and efficient template-mediated synthesis of macromolecules (e.g., new enzymes) and nanostructures would be an advance of the art.

### SUMMARY

The present invention relates generally to methods and systems for the template-mediated synthesis of macromolecules and nanostructures, and to the macromolecules (e.g., peptides, proteins and enzymes) and the nanostructures synthesized by the herewith methods and systems. The present invention further relates to using the macromolecules and nanostructures prepared by the methods and devices of the invention for useful processes, for example, cellulose degradation and other enzymatic processes.

In one aspect, the present invention is directed to a template-based system for assembling a macromolecular structure comprising a surface comprising a plurality of single strand DNA molecules which are substantially parallel, substantially inline each from one end, and substantially equally spaced apart, wherein each DNA molecule has a distinguishable length and a known sequence. The macromolecular structure assembled by the system can be a polypeptide, e.g., an enzyme, such as, cellulase. The macromolecular structure assembled by the system can also be a nanostructure. The polypeptides of the invention can comprise a secondary skeleton, including (a) thiol-maleimide linkages at one or more residues, (b) thiol to gold linkages at one or more residues) and/or (c) cyclized thiol linkages between two or more residues. The surface, in one aspect, can be gold. The single strand DNA molecules can comprise alpha-Sulfur single strand DNA molecules or alpha-Sulfur oligonucleotides bound to the gold surface.

In another aspect, the present invention is directed to a method for preparing a template-based system for assembling a macromolecular structure, comprising the steps of: (a) providing a substrate having a surface and a doormat region, (b) providing a plurality of single strand DNA molecules, each having a distinguishable length and a known sequence and each having a bead bound to one end and each bound at the other end to the doormat region, and (c) stretching the plurality of single strand DNA molecules so that they are substantially parallel, substantially inline each from the doormat region end, and substantially equally spaced apart on the surface. The single strand DNA molecules can be stretched by applying an electrical force acting on the negatively charged phosphate backbone of the DNA, applying a magnetic force acting on the backbone and/or a magnetic bead, and/or applying a centrifugal force acting on the bead. The single strand DNA molecules can comprise alpha-Sulfur single strand DNA molecules that are bound to a gold surface to provide the template-based system. Alternatively, alpha-Sulfur oligonucleotides can be hybridized to their complement nucleotides of the single strand DNA molecules, the hybridized alpha-Sulfur oligonucleotides can be bound to a gold surface, and the bound alpha-Sulfur oligonucleotides can be released from the single strand DNA molecules to provide the template-based system. The method can further comprise hybridizing oligonucleotides to their complement nucleotides of the alpha-Sulfur single strand DNA molecules of the template-based system, encapsulating the hybridized oligonucleotides with an elastomer, and releasing the hydridized nucleotides from the alpha-Sulfur oligonucleotides and the gold surface to provide a platform DNA system.

In another aspect, the present invention is directed to a method for assembling a macromolecular structure comprising the steps of: (a) preparing a surface comprising a plurality of single strand DNA molecules which are substantially parallel, substantially inline each from one end, and substantially equally spaced apart, wherein each DNA molecule has a distinguishable length and a known sequence, (b) sequentially hybridizing nucleotide-coupled amino acid chimaeras to complementary nucleotides of the single strand DNA molecules, (c) forming covalent bonds between each adjacent amino acid to form the macromolecular structure, and (d) disassociating the macromolecular structure from the coupled nucleotides. The macromolecular structure can be a polypeptide, e.g., an enzyme, such as, cellulase. The method can further comprise the step of attaching a secondary skeleton to the polypeptide via sulfur linkages at one or more amino acid residues. The secondary skeleton can comprise one or more linkages selected from the group consisting of: (a) thiol-maleimide linkages at one or more residues, (b) thiol to gold linkages at one or more residues, (c) cyclized thiol linkages between two or more residues, and combinations thereof.

It is to be understood that both the foregoing general description and the following detailed description are exemplary and are intended to provide further explanation of the invention claimed. It is also to be understood that features of each embodiment can be incorporated into other embodiments, and that optional features described in connection with one embodiment in accordance with the invention can be incorporated into other embodiments in accordance with the invention.

### BRIEF DESCRIPTION OF THE DRAWINGS

The accompanying drawings, which are incorporated in and constitute part of this specification, are included to illustrate and provide a further understanding of the method and system of the invention. The following drawings are exemplary only and are not meant to limit the present invention.

FIG. 1 shows a top-view schematic illustration of a master DNA system comprising a plurality of parallel, straightened, and stretched single strands of ssDNA in a doormat configuration.

FIG. 2A shows an individual stand of single strand DNA functionalized at the 5′ end with thiol and at the 3′ end with biotin that is complexed to a streptavidin-functionalized magnetic bead. FIG. 2B shows two exemplary methods to functionalize the single strand DNA with 5′-thiol and 3′-biotin.

FIG. 3 shows a perspective-view schematic illustration of a gold transmission electron microscope (TEM) grid that has been functionalized to provide a “doormat region” for the single strands of ssDNA to bind to via a MUAM/SSMCC linker to a thiol group.

FIG. 4 shows the asymmetric localization of a single strand DNA molecule with its thiol end attached to a gold surface via a MUAM/SSMCC linker.

FIG. 5 shows a coiled-globule ssDNA, end-labeled with biotin and thiol and attached to a streptavidin-coated magnetic bead and a gold surface via linker molecules (top), and the same ssDNA molecule in a partially stretched configuration (bottom).

FIGS. 6A to 6E show a schematic illustration of a method to prepare a template DNA array from a master DNA array.

FIG. 7 shows the reaction of deoxyadenosine monophosphate with arginine via a cystamine linkage to provide a chimaera of the amino acid linked to the nucleotide.

FIG. 8A shows a schematic illustration of the basic concept of bonding of a chimaera, comprising an amino acid and a nucleotide, to a template DNA strand by nucleotide pairing. FIG. 8B shows a schematic illustration of a fully realized polypeptide sequence as attached to the template DNA strand.

FIG. 9A and FIG. 9B show a method of synthesizing a polypeptide using a template DNA system, wherein the resultant polypeptide is covalently linked to its nucleotide chimaeric partners and thus can be complexed to either a secondary skeleton via a scaffold with DNA binding capacity or to a template with similar nucleotide sequence.

FIG. 10A, FIG. 10B, and FIG. 10C show a method of synthesizing a polypeptide using a template DNA system, wherein the resultant polypeptide is covalently linked to its template DNA strand through cystamine linkages, which can be utilized as shown to complex to, or self-polymerize to resultantly create, a secondary backbone for scaffolding purposes.

### DETAILED DESCRIPTION OF THE INVENTION

### Preparation of a Master DNA System

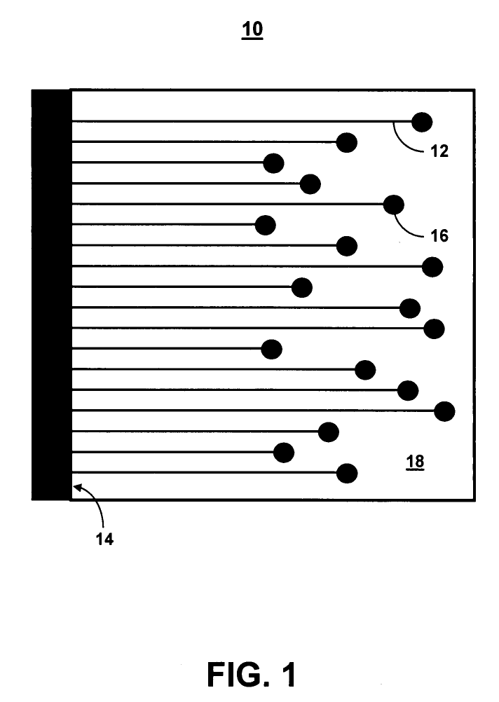

FIG. 1 is a top-view schematic illustration of a master DNA system 10 of the present invention. The master system 10 can be prepared by stretching single strands of DNA to prepare a surface comprising a plurality of single strand DNA (ssDNA) molecules 12 that are substantially inline, substantially adjacent, and substantially parallel. The DNA strands 12 can be of the same length or of different lengths (as shown). One end of each strand 12 is bound to a surface or “doormat region” 14. The other end is bound to a bead 16 that facilitates the stretching of the ssDNA molecules 12. The master DNA system 10 can be formed on the surface of a plastic film or other substrate 18. Described below is an exemplary method that can be used to fabricate the master DNA system 10.

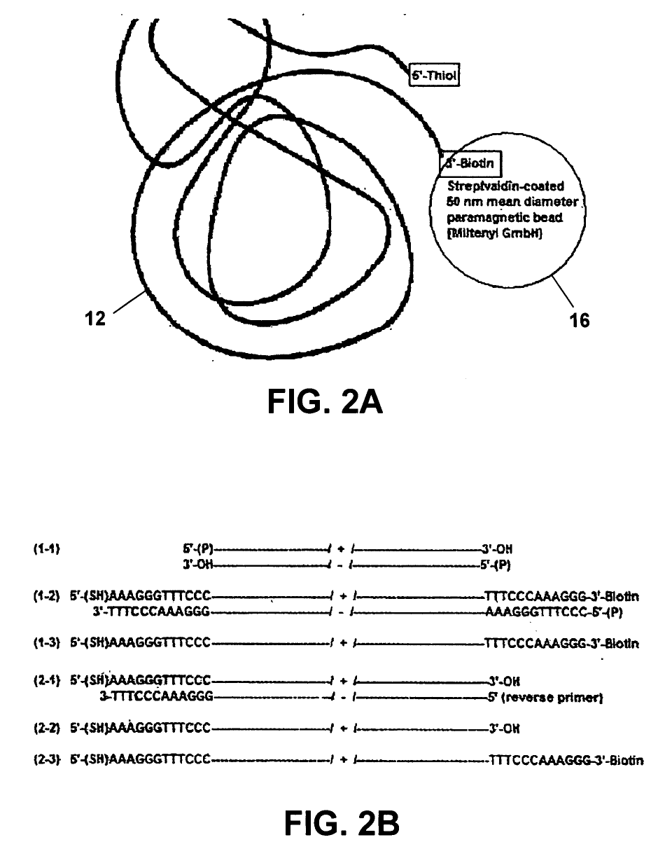

FIG. 2A is a schematic illustration of a ssDNA 12 of a specific length that is modified on one end with thiol (—SH) and on the other end with the molecule biotin (—B). For example, each individual strand of ssDNA can be 100 to 10,000 base pairs long and can be 5′-thiolated and 3′-biotinylated (as shown). The ssDNA can be generated by either (1) end-labeling of restriction-endonuclease-digested dsDNA with hybridized dsDNA oligonucleotides, resulting in biotinylation and thiolation of one strand (plus +), or (2) polymerase chain reaction (PCR) with a 5′(—SH)-labeled primer, followed by melting of the PCR product into ssDNA, and T4 RNA ligation of the thiolated strand with a 3′(Biotin)—labeled oligonucleotide.

FIG. 2B shows two exemplary methods for the functionalization of single strand DNA with 5′-thiol and 3′-biotin. The methods are directed to functionalization of the upper, or plus (+) strand. Starting with double strand DNA of known length and sequence (1-1), double strand DNA linkers are ligated specifically to the ends of (1-1) in a reaction catalyzed by DNA Ligase, such that the positive (+) strand receives a 5′-thiol and 3′-biotin function, respectively (1-2). The double strand DNA is then converted to single strand DNA, by standard methods such as heat and extremes of pH and/or salt concentration, into the desired product molecule (1-3). Additionally, the starting material (1-1) can also be used as a template for polymerase chain reaction (PCR) utilizing a 5′-functionalized thiol primer and a reverse primer having no unique function (2-1). After removal of the negative (−) strand by techniques just described, the intermediate molecule (2-2) can be 3′-biotin-functionalized by single strand ligation of a primer having that function as shown (2-3), in a reaction catalyzed by T4 RNA Ligase. Thiol and biotin groups can be functionalized on either the 5′ or 3′ ends of the product molecule by variations on the above methods. Additionally, the product molecules shown (1-3 and 2-3) need not necessarily be similar in the sequence of the primers used for final functionalization and/or intermediate processing (as shown in 1-2, 2-1 and 2-2).

The present invention is not limited to any particular method of preparing ssDNA, or any method of biotinylation, or thiolation. Other labels are within the scope of the present invention, so long as the particular labels that are used enable one of ordinary skill in the art to localize the ssDNA to a “doormat” configuration (i.e., substantially inline, substantially adjacent, and substantially parallel ssDNA molecules joined each at one end of a surface). For example, alternative labels include a dioxigenin (DIG) ligand binding to an anti-DIG antibody (Smith et al., Science 258, 5085 (1992)) or an amine ligand binding to a primary aldehyde-containing receptor (Fixe et al., Nucleic Acids Research, page 32 (2004)). The former can be used for non-covalent bond-based linking of ssDNA to a bead, whereas the latter can be used for covalent bonding between the ssDNA and the bead.

Magnetic beads 16 covered with the molecule streptavidin (—SA) can be complexed with the biotinylated ssDNA molecules to form a ssDNA magnetic bead molecule. For example, the magnetic beads 16 can have a mean diameter of 50 nm. The present invention is not limited to 50 nm-sized magnetic beads and can utilize any usefully-sized beads so long as they allow the ssDNA molecules 12 to be manipulated by magnetic, electrical, gravitational, optical, and/or centrifugal fields, referred to herein as “translocational forces,” to facilitate their localization to the “doormat” configuration. In general, the beads are preferably of a usable size, mass, and susceptibility to be translocated by such fields, and also able to bind biotin. Alternatively, the beads can comprise a non-magnetic material, wherein the ssDNA can be pulled simply by the greater mass of the bead, or an optically-sensitive glass or plastic, where the ssDNA can be pulled by virtue of coherent light sources.

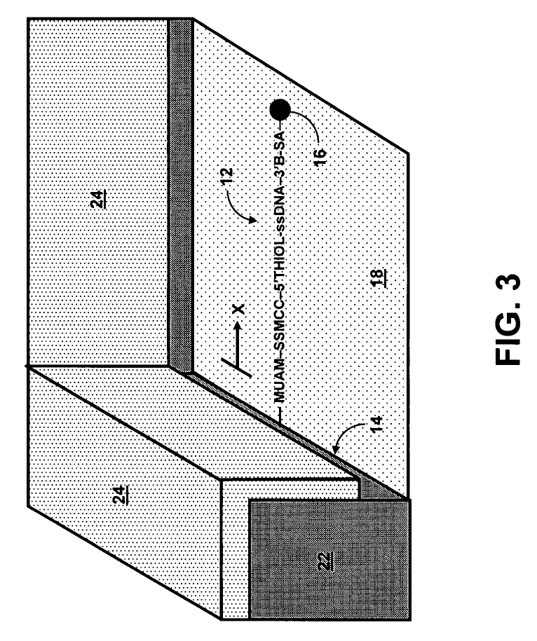

FIG. 3 is a perspective-view schematic illustration of the preparation of a gold transmission electron microscope (TEM) grid that can be used to provide a gold “doormat region” 14 for the ssDNA 12 to bind to (for ease of illustration, only one strand 12 of a master system 10 is shown in FIG. 3). The gold TEM grid 22 was in a square mesh pattern, like a net, and has a compass marker in its middle to indicate direction and orientation. Only a portion of a single square mesh is shown in FIG. 3. The doormat region 14 can be prepared by forming a protective upper layer 24 on which ssDNA can be blocked from binding to the grid. The thin layer 24 covers most of the grid walls, leaving a thin, narrow edge (the “doormat region” 14) at the base of the grid 22 still exposed and capable of binding to thiolated DNA. Preferably, the height of the doormat region is less than about 100 nm.

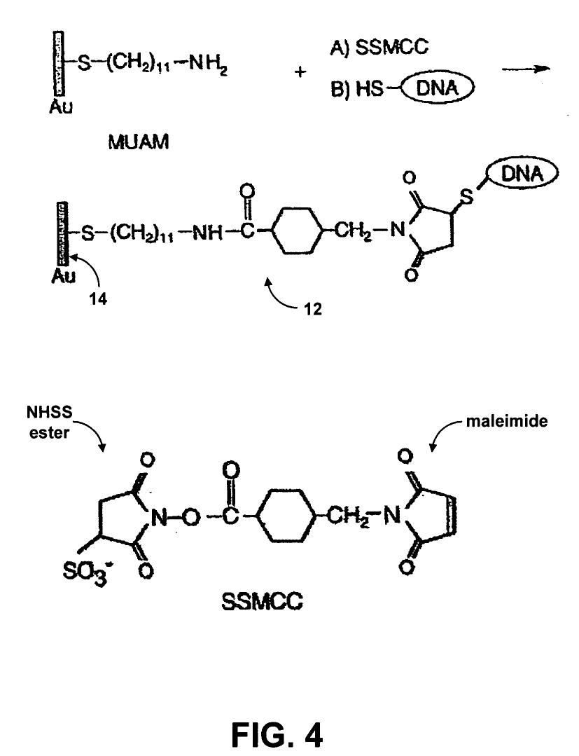

To prepare the doormat region, a gold TEM grid (e.g., PELCO® 400 mesh Au TEM, Redding, Calif.) is thoroughly cleaned with hot water, chloroform, and ethanol, and vacuum dried. The top of the grid is covered with a thick layer of liquid Butvar, the solvent for which is chloroform. The layer thickness can be about 20 microns (i.e., the grid thickness). The inner surfaces of the gold TEM grid can be modified with intermediate (linker) molecules to bind the thiolated ends of ssDNA. This can be done in a way such that the ssDNA preferentially bind substantially to the bottom, doormat region, of the grid, and not substantially to the tops or sides. FIG. 4 shows a schematic illustration of the functionalization of the doormat region 14 of the gold TEM grids with MUAM and SSMCC linker molecules. See J. M. Brockman et al., J. Am. Chem. Soc. 121(5), 8044 (1999). In this example, the heterobifunctional linker SSMCC is used to attach 5′-thiol modified oligonucleotide sequences to reactive pads of MUAM. The doormat can be prepared by coating the bottom of grid with MUAM in ethanol. The ethanol very slightly dissolves some of the Butvar plastic on the inner walls of the bottom of the grid, thereby exposing just enough gold surface for a “doormat” to be created, by solubilization and capillary action. The thick Butvar layer can then be peeled off with a forceps and the grid examined with an optical microscope to ensure that no plastic remains. The SSMCC linker contains a N-hydroxy-sulfo-succinimide (NHSS) ester functionality (reactive towards amines) and a maleimide functionality (reactive towards thiols). The surface is exposed to a solution of the SSMCC linker, whereby the NHSS ester end of the molecule reacts with the amine end of the MUAM in the doormat region. Excess linker can then be rinsed away.

Another option, alternative to the creation of “doormats,” is the anchoring of DNA to gold spots, created by photolithography, from which MUAM-SSMCC type linker molecules may bind thiol-terminated ssDNA. A linear grouping of gold-filled circles, squares, or any other shape, can be formed by vapor deposition onto similarly pre-lithographed base metal, which can be titanium. The resulting “line of gold spots,” can be substantially equally spaced apart (preferably 50 nm spacing distance, in the (y) direction), substantially linear, and substantially equivalent. With regard to it's role as a foundation for mounting ssDNA via linker molecules, it is preferred that each spot be of a size and chemical composition that only a very limited number of MUAM molecules will bind. Such functionality is preferred in order to avoid too many SSMCC, and thus too many ssDNA, molecules from binding to each spot. As designed, each gold spot will eventually define an individual master ssDNA molecule equally spaced apart at 50 nm increments in the (y)-direction, significantly improving the identification of each individual DNA strand via the exact localization of it's starting point after stretching.

Also, the line of gold spots can be fabricated onto a metal bar or the inner bottom edge of a TEM grid, as with the constructed “doormat.” That is, the metal foundation atop of which is the (+/−y) line of 50 nm-spaced gold spots can be localized to the same location as the doormat, facilitating the localization of ssDNA-bead assemblies from a common (y-direction) starting line. As will be specified, the stretching of the ssDNA will be performed in a manner that considers advantages presented by translocational forces in the (+z) direction, i.e., upwards away from the surface, as well as in the (+x) direction, i.e., the main direction of stretch that is away from the doormat or line of spots. Therefore, is preferred that the metal foundation upon which the spots will be lithographed will be a plane angled downwards (−z direction) towards the direction of stretch (+x), and localized on the bottom inner surface of a TEM grid. Such a structure can be fabricated by techniques familiar to those in the materials science and other fields. In consideration of the downwards angle of the preferred structure and its location directly adjacent to a potential doormat region, the structure described will be referred-to as a “doorstop.”

Following the preparation of the doormat region of the grid, the underside of the gold TEM grid 22 can be coated with a thin plastic film 18 that is transparent to the electrons used in transmission electron microscopy. Prior to coating, MUOL (11-mercaptoundecanol) can be added to block any unbound gold (i.e., from the top of the doormat to the “ceiling” and the top and bottom sides of the grid) with a hydrophilic, hydroxyl terminus. The bottom of the MUOL-coated grid can then be coated with a thin layer of dry Butvar (e.g., a thickness of about 100 nm). Dry Butvar is used so that the MUAM-SSMCC linker and MUOL blocker are not dissolved by a chloroform solvent. Any plastic film that is TEM transparent, able to be surface-modified with chemicals that enable DNA stretching, and able to withstand translocational forces can be used for this step. For example, ethylene vinyl acetate (EVA) is another suitable plastic film.

ssDNA-magnetic bead molecules can be added to the TEM grids coated with the plastic film. The ssDNA can be (5′ or 3′)-thiol-terminated and (3′ or 5′)-biotin-terminated and pre-linked to SA-coated beads. For example, the linker-functionalized grids can be spotted with 5′-thiol-modified ssDNA that reacts with the maleimide groups, forming a covalent bond to the surface monolayer of linker molecules to provide the bound DNA strands. The solvation (liquid environment) can be changed to one in which the thiolated end of the ssDNA bind to the linker molecules (MUAM-SSMCC). The solvation conditions can be changed by neutralizing the reduction potential in the buffer in which the ssDNA-magnetic bead molecules are solvated (10 mM DTT in 1X T4 RNA Ligase Buffer) with a redox equivalent amount of H₂0₂ and then changing the buffer to 10 mM phosphate/20 mM EDTA/100 mM NaCl. This new solvation state preserves the biotin-SA bonds, yet promotes thiol binding to the maleimide groups on the linkers. Other solvation conditions can be used to bind the ssDNA. The ssDNA 12 bind on the inner sides of the grid, and close to the bottom near the transparent plastic film, i.e., in a “doormat” configuration.

The plastic film 18 can be coated, for example with poly-L-lysine (PLL) to give it a slightly positive charge so that the ssDNA will bind tightly to the Butvar with the anionic phosphate groups side-down and the cationic bases side-up after stretching. The concentration of the PLL can be selected to give the Butvar about one positive charge for each negative charge contributed by the doormated DNA. For example, assuming 100,000 strands of 6000 nt ssDNA, the Butvar can be coated with 100 ppm poly-L-lysine (PLL) in water for 2 hours and in 100% relative humidity, followed by a rinsing with water. The washing leaves a mono-molecular coating of PLL on the Butvar. At the same time, a magnetic field (e.g., by using a hand-magnet) can be applied towards one side of the square mesh pattern (the “left” side) of the grid, and also downwards at a 45° degree angle. This magnetic field facilitates the ssDNA 12 (each bound to a magnetic bead 16) to bind only the bottoms of the inner sides of the TEM grids, and also only to the left side in FIG. 3, i.e. the “doormat” configuration. Therefore, the ssDNA molecules bind at one end “on the bottom of a door” rather than “running up the wall” to the ceiling or “across the floor” on the Butvar. Binding of the DNA only to the doormat region enables quality assurance determination of the DNA sequence, as will be described later.

After allowing the ssDNA to form thiol-to-gold bonds via the linker molecules on one side of the TEM grid close to the bottom thereof, the solvation can be changed to one wherein the ssDNA molecules tend to be in less of a tangled/coil-like configuration, e.g., by changing to 10 mM phosphate buffer, pH 6.8. This resolvation preserves both the biotin-SA bonds and the thiol-maleimide bonds.

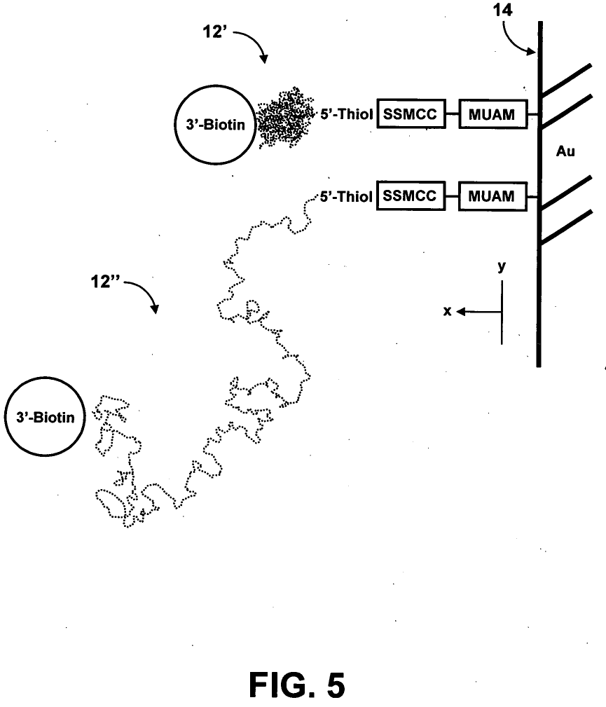

FIG. 5 is a schematic illustration of a coiled-globule ssDNA 12′, end-labeled with biotin and mounted to the doormat region 14 of the gold TEM grid via the linker molecules, and a partially extended ssDNA 12″ pulled in the (+x) direction as a result of translocational forces. The translocation force vector is from right to left in this illustration. The initial elongation (stretching) of the “doormated” ssDNA away from the TEM doormat region in the (+x) direction can be due to any combination of electrical forces acting on the negatively charged phosphate backbone, magnetic forces acting on the backbone and/or the magnetic bead, or inertial (e.g., centrifugal, centripetal, or gravitational) forces acting on the bead. See http://xpcs.physics.yale.edu/boulder1/node 11.html and http;//xxx.lanl.gov/PS_cache/cond-mat/pdf/o111/0111170.pdf.

The bound DNA 12 can be initially stretched by applying an electrical force acting on the negatively charged phosphate backbone of the DNA. The grids with DNA can be placed in a self-made electrical cell (e.g., prepared as a glass microscope slide with a 1.2 cm square trough, silver electrodes 1 cm apart attached to two AAA batteries) and a small electric field (e.g., approximately 7 Volts and 1 mAmp as measured with an electrometer) facilitating an initial stretch of the DNA molecules. After about 30 minutes, the electric field can be turned off.

The bound DNA 12 can then be stretched by a magnetic force acting on the backbone and/or magnetic bead. Therefore, a second magnetic field (e.g., applied with a hand-held magnet) can be directed from left-to-right (i.e., doormat region on the left, with ssDNA being stretched to the right as shown in FIG. 3) and slightly upwards (i.e., in the (+z) direction, going away from the ssDNA on the surface), in order to do a longer term stretching of the doormated ssDNA. The slight upwards directional vector of the magnetic field helps pull the ssDNA away from the plastic surface, which otherwise would inhibit stretching because the positively-charged surface would strongly adhere to the negatively-charged DNA. This “left-to-right and upwards” magnetic field can be left on for about 8-16 hours to pull the DNA to nearly their fully extended lengths. In addition, the solvation environment of the DNA can be changed to that of a less polar nature (e.g., 20% [vol] glycerol in 10 mM phosphate buffer, pH 6.8), which helps keep the ssDNA strands from assuming entangled conformations, as well as decreasing intra-strand hydrogen bonds (i.e., “stickyness”). Additionally, an upper solvent coating of hydrophobic liquid, such as mixed hexanes, can be added to the ssDNA that is being stretched to prevent evaporation of the lower aqueous solvent during the hours of stretching.

The bound DNA 12 can finally be stretched by a centrifugal force acting on the bead. The grids can be placed in a centrifuge for the final straightening using the weight of the magnetic beads as an “anchor.” The orientation of the grids can be verified by looking at the compass marker under light microscopy, and the grids can be placed into centrifuge mounts that hold the thin, gold grids in place securely without warping. During centrifugation, the hydrophobic layer (e.g., a previously added layer of mixed hexanes) can be sheared-off (ablated), leaving only the previous solvent layer, which can be allowed to evaporate during centrifugation, resulting in a nearly dried surface.

Other techniques can also be used to prepare the master DNA system. For example, a linearly grooved surface can be used to encourage the formation of arrays of ssDNA that are substantially parallel, substantially inline each from one end, and substantially equally spaced apart. The raised portion of the grooved surface can be comprised of hydrophobic molecules which repel the highly negatively-charged master ssDNA and force their alignment onto positively-charged “gutters.” For example, a functionalized surface can be constructed by 1) photolithographic fabrication of gold lines in the (x) direction on a metal or polymer surface, approximately 25 nm wide and 50 nm apart, equal to just under the fully-extended length of the master ssDNA used; 2) exposure of the gold to hexadecanethiol (HDT, formula: CH₃—(CH₂)₁₁—SH) which forms hydrophobic “risers” on the (x) direction; and 3) functionalization of the intervening troughs to have a positive charge for binding to ssDNA. See Tarlov M J, et al., J. Am. Chem. Soc. 1993: 5305, and CaoH, et al., Appl. Phys. Lett. 2002: 3058, incorporated herein by reference.

Additionally, the (+/−y)-directional line of gold spots on “doorstops,” previously described, can be fabricated on the initial portion of such an array of grooves and gutters. Specifically, each gold spot can be localized to be on the beginning of each linear, catonic depression, on the starting line of such a gutter. Such an arrangement will enable stretching of master ssDNA directly onto the cationic depression by translocational forces that are substantially in the (+x) direction and is described by the textual illustration thusly that represents three differently-sized ssDNA molecules facilitated in their stretching and alignment by the aforementioned risers (dashes, =) and doorstops (represented by bullet indent markers):

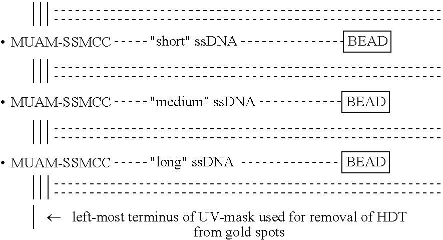

In order to enable HDT-coating of the gold risers but not that of the doorstop-localized gold spots, one option is to fabricate, via photolithography and other methods, both the gold spots arrayed linearly in the (y)-direction, and the raised gold lines defined in the (x)-direction, simultaneously. All fabricated gold surfaces can then be coated with HDT in order to form hydrophobic surfaces. Subsequently, a photolithographic mask (familiar to those practiced in the art) can be positioned in such a way that only the location of the “doorstop” is exposed to subsequent wavelengths and energy of UV light that severs gold-to-thiol bonds. In the illustration above, the left-most terminus of the mask has been conceptually defined as the region (|∥ . . . , continuous from top to bottom), where the area to the left of such would be exposed to the UV light. After elimination of the HDT molecules coating the line of spots, and expected washing and solvation steps, MUAM, SSMCC and, ultimately, master ssDNA and beads can be localized correctly on the line of spots, as described, and not on the hydrophobic risers.

As it is expected that the aforementioned photolithography likely cannot be performed on plastic or other polymer materials transparent to TEM analysis, quality determination of the geometrical orientation of the master ssDNA stretched and aligned as such can be performed on a “replica” of the above construction. The latter being composed of a metal or other material more amenable to photolithography of gold and other metals. Such a replica can be generated by the templating methods described below, and can be defined as either an exact or mirror-image complement of the original, master ssDNA stretched on doormats and grooves, however composed of a material that is amenable to analysis by TEM, SEM, AFM, other electron-microscopy based methods, unrelated methods that can analyze such constructions, or variations thereof.

Alternatively, or additionally, stretching can be performed on a curved surface with radial signature relative to the length of the ssDNA strand to be stretched of between 1 and 2.5 milliradians, for example. For a 10,000 base long ssDNA strand, this corresponds to a cylinder of between 0.5-1.0 mm diameter. The advantage of stretching on a curved surface is threefold: 1) a distal surface that falls downwards, i.e., a “horizon,” creates more opportunity for the portion of ssDNA nearer to the bead to become straightened, as opposed to a flat surface where that distal portion of the DNA has fewer conformational options in the (+y) direction; 2) a curved surface generally has fewer depressions than an imperfectly flat surface, into which depressions in the (−y) direction a portion of the ssDNA can become trapped and cease to be stretched or aligned; 3) a curved surface enables centrifugation not only in the (+x) direction, as described above, but also radially, which again takes advantage of the inertial mass of the bead to help straighten and align the ssDNA; and 4) the horizon described forms a natural pulling vector in the (+y), or upwards direction, on the ssDNA, which facilitates stretching and aligning by pulling the ssDNA away from the surface (again, the surface is cationic and, though facilitating attachment of the negatively charged ssDNA for subsequent processing steps, otherwise inhibits stretching if it complexes to the DNA during its transition from coiled globule-to-linear conformation).

Returning now to FIG. 3, after stretching, several hundred copies of ssDNA remain which are mounted on the doormat region of the gold TEM grid, on the inner sides and near the bottom, and which are stretched from left-to-right. This preparation provides a master DNA system, which can be converted to a template DNA system as described below.

To verify that the master DNA system comprises a plurality of single strand DNA molecules that are substantially inline, substantially adjacent, and substantially parallel, the prepared grid can be fixed and stained using standard TEM protocols and visualized under TEMicroscopy. If properly assembled, the TEM will show straight lines of beads parallel to the side wall, indicating that substantially all of the ssDNA molecules are mounted (doormated) as desired and that they are stretched uniformly (the beads will be inline if the ssDNA strands are of equal length —however ssDNA of different lengths can also be used). In addition, the distance from the line-of-beads to the gold wall will be approximately that of the theoretical length of fully stretched ssDNA—approximately 0.5 nanometers for every base unit, or about 3000 nm for a 6000 base-long ssDNA that is mounted and stretched per the above methods and variations thereof.

### Preparation of a Template DNA System

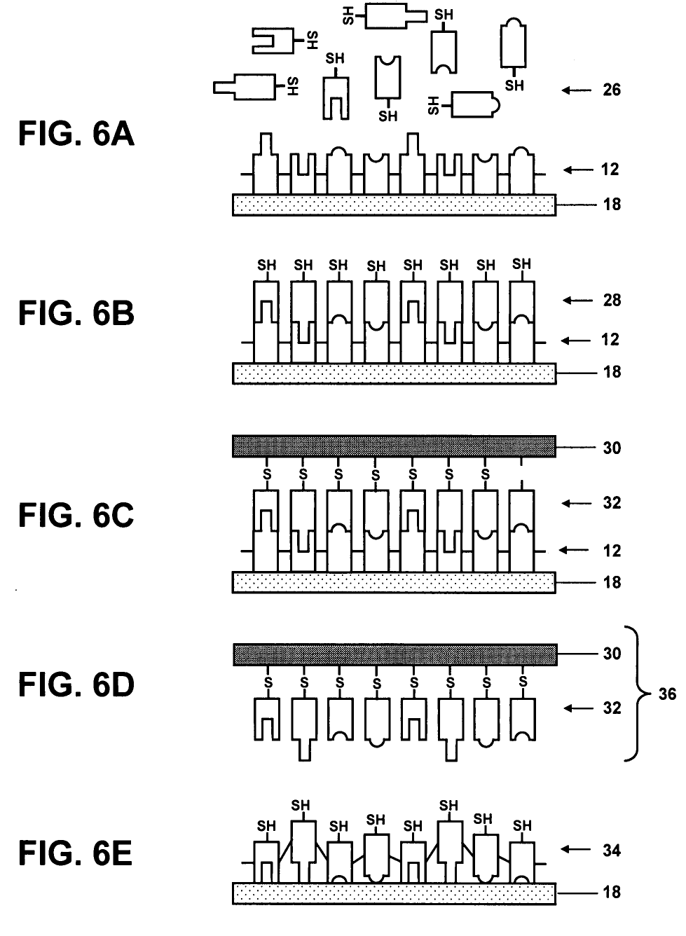

FIGS. 6A-6E show a schematic illustration of a method to prepare a template-based system from the master DNA system of the type described above, also referred to herein as Single Strand Template Manufacturing (SSTM), which also refers to methods for the synthesis of polypeptides, other polymers, and nanostructures as will be described. To prepare the exemplary template DNA system described below, the exemplary master DNA system described above was used. The master DNA system comprises substantially stretched, straightened and parallel single strand DNA molecules (e.g., several thousand strands each being 6000 nucleotides in length and comprising the same sequence) which are fixed onto TEM plastic.

FIG. 6A shows a single strand of DNA 12 of the master DNA system 10 that can be prepared with standard nucleotides (i.e., non a-S nucleotides) after the plastic 18 carrying the affixed master DNA is removed from the gold TEM grid and mounted securely for further processing.

Short alpha-Sulfur ssDNA oligonucleotides 26 that comprise the entire complement of the master DNA sequence are allowed to hybridize to the master DNA 12 under conditions that promote such hybridization. These oligonucleotides carry a sulfur atom in place of one of the oxygens on the phosphate group and are also referred to as alpha-Sulfur (a-S) oligonucleotides. Short a-S oligonucleotides can generally be produced by standard phosphoramidite DNA synthesis. These short oligonucleotides can be phosphorothioate-modified on their 5′-phosphate backbone. In the example, the short ssDNA oligonucleotides can be 30 nucleotides (nts) in length, or 0.5% of the master sequence. However, the length of this oligonucleotide is not limited to 30 nts and can be any suitable length. The a-S oligonucleotides will bind to a gold template surface, as will be described later. However, other coupling chemistry and template surfaces can also be used. For example, a-S oligonucleotides can bind to a maleimide-coated surface or amine backbone oligonucleotides can bind to an aldehyde-coated surface. Alternatively, biotinylated backbone oligonucleotides can bind to an SA-coated surface.

As shown in FIG. 6B, each oligonucleotide 26 (100,000 in total to correspond to the complete complement) can be hybridized to its complement DNA sequence on the master DNA strand 12. The resulting template DNA strand 28 comprises a plurality of oligonucleotides atop a straight, continuous master DNA sequence, but addressed uniquely at each location. For example, each ssDNA molecule (at 6000 nts) of a master DNA system will hybridized to approximately 200 a-S ssDNA oligonucleotides. The skilled artisan can determine the optimal concentration of ssDNA oligonucleotides to prepare a template-based system to complement the master DNA system having strands preferably being 50 nm (bead diameter) apart.

Following hybridization, the solvation can then be changed to one that preserves: (i) the fixation of the master DNA strands 12 on the plastic 18, and (ii) the hybridization of the a-S oligonucleotides 28 on the master DNA strands 12, while also allowing the a-S backbone to bind to a gold surface. In this example, the solvation can be changed to 50 mM Na3Citrate/10 mM NaCl/no EDTA, pH 7.4 (the ssDNA on the dried surface being equilibrated to this buffer). As shown in FIG. 6C, a cleaned gold surface 30 can then be pressed onto the side of the plastic film 18 containing the DNA 12, thereby sulfur-bonding the a-S oligonucleotides 32 to the gold 30 and also in a manner that replicates the original straight orientation of the master ssDNA 12 onto the template DNA 28 forming a template DNA system having a structure that is the mirror image of master DNA system 10. The gold surface 30 can be made by a number of different techniques, most commonly vapor deposition of gold onto titanium-coated glass, polymer or another metal. Any suitable source of gold surface or method for preparing such gold surfaces is contemplated by the present invention.

After hybridization, the system can be heated to a temperature sufficient to break the hybridization bonds and release the master DNA system. As shown in FIG. 6D, the gold surface 30 containing the transferred mirror-image a-S probe ssDNA 32 is referred to as the template-based DNA system 36.

The same gold-based, or other semi-permanent, template can be iteratively exposed to a multitude of the same or different a-S oligonucleotides hybridized to master ssDNA. The effect of this is to increase the density of DNA on the template system with each application of DNA complementary to original master. For example, a next iteration master ssDNA complemented by a-S oligonucleotides (master 2), that is equivalent to the first master system templated as such (master 1), can be affixed as already described to the same template, effectively doubling the ssDNA density on the template. Given well-positioning of the initial “doorstop” and/or “doormat” of master 2 to the location and orientation of the same from master 1 on the template (i.e., beginning at the same starting (y-axis) line), and factors related to positioning on the x-axis the intrastrand distance of ssDNA on the template can, for example, be cut in half from 50 nm to 25 nm. Subsequent iterations as described can result in even higher template ssDNA densities and smaller inter-strand (y-axis) DNA spatial distances.

The iterative templating described is not subscribed or limited to iterations of templating master complements having the same x-axis orientation. Subsequent complements of initially stretched or otherwise geometrically-arrayed ssDNA (master N) can be, for example, 90 degrees to the original linear array—resulting in square or cross-hatched pattern template systems.

Relatedly, smaller size and differently-patterned complements of masters can be templated on desired locations on a template, in patterns that are also desired. Such constructions can, for example, define a higher density region of ssDNA on a template that may describe the desired location of one of the exemplary eventual product applications of such a heterogeneity in ssDNA density: (i) a high density random access memory (RAM) core, (ii) a region where polypeptide products would be synthesized at higher density, (iii) a region where, enabled by the unique ssDNA sequence having been templated to such an area, quality assurance-related materials may be localized in order to test the polymers having been synthesized on other areas, and any other application where site-specific localization of a higher density of materials, and/or oriented in different directions, than other portions of the template system is desired. The concepts of iterative templating as just described may be illustrated by the following:

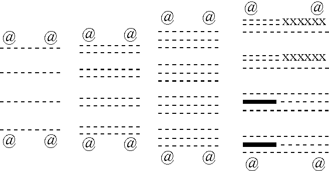

Where, from left to right, the textual illustration above describes the following: FAR LEFT—an ssDNA template constructed from a single iterative series of one or more ssDNA masters. MIDDLE LEFT—the same template constructed from additional masters via iterative templating. MIDDLE RIGHT—the same template after having gone through yet additional templating iteration(s). FAR RIGHT—a different template having undergone a comparable series of iterative templatings that is distinct from the template immediately preceding by virtue of having templated: (i) a cross-hatched master or masters in its upper right quadrant, and (ii) an ultra-high density master array, in the same (x) direction, in it's lower right quadrant, as illustrated by (X) and (==), respectively. The @ symbol represents, conceptually, orientation markers on the periphery of each template that would be used for the proper alignment and placement of each iterative series of master sDNA complements.

Alternatively, as shown in FIG. 6E, the master DNA system can be prepared directly as a template DNA system 36. The master DNA system can be prepared with a-S modified single strand DNA 34. In such a case, the master DNA system and the template DNA system are the same. a-S ssDNA 34 can be prepared using any known or suitable method in the art, such as, for example, polymerase chain reaction (PCR) using a-S deoxyribonucleotide triphosphates (a-S dNTPs) in place of standard dNTPs. For example, 10,000 copies of 6000 nt-long a-S ssDNA can be stretched and straightened across a surface as described in the above master DNA preparation example and then bound directly to a cleaned gold surface 30 to provide a template DNA system 36 as shown in FIG. 6D. The different means of solvation, surface charge density of the plastic, electric, magnetic and inertial fields can be modified for optimization of stretching and affixing a-S ssDNA as opposed to regular ssDNA. Such modifications can be determined without undue experimentation by one of ordinary skill in the art.

The template DNA system can be assessed for quality (e.g., tested to be sure the DNA strands are substantially parallel, straightened and stretched). In order to perform a quality assurance (QA) determination of the template DNA system, a partial mirror-image copy, or partial complement, can be produced. This can be done by addition of 50 nt-long, 5′ and 3′ biotinylated probe oligonucleotides to the template and allowing them to hybridize to the template DNA array. ssDNA oligonucleotides that are approximately 50 nt-long can be modified with the molecule biotin on both ends (5′ and 3′). The length of these probe oligonucleotides is not limited to 50 nts and can be any suitable length.

After addition of the probes, the solvation of the system can be changed to one that preserved the hybridization of the probes to the template DNA system but facilitates binding of the probe oligonucleotides to a subsequent QA surface. In this example, the solvation can be changed from 10 mM phosphate buffer/100 mM NaCl/20 mM EDTA, pH 7.4 to 10 mM phosphate buffer/pH 6.8. The QA surface can be a thin plastic film that is transparent under TEM, and that is also positively-charged to promote binding of the negatively-charged probe oligonucleotides. This plastic can be either pressed-onto the hybridized template DNA probes or allowed to polymerize from a liquid state. For example, the template can be placed upside-down onto a droplet of Butvar in water, or the Butvar can be layered on top of the template and another TEM grid can be incorporated to hold the Butvar for subsequent QA analysis by electron microscopy. After hybridization, the system can be heated hot enough to break the hybridization bonds, but not hot enough to alter the orientation of the probe oligonucleotides or to prevent binding of the probe oligonucleotides to the plastic. The grids used for QA do not have to be gold, but can be, for example, nickel or copper.

Finally, the TEM plastic film containing the probe oligonucleotides can be carefully peeled-off the template and electron-dense probe elements can be added to visualize the geometrical orientation of the probe oligonucleotides that themselves mirror-image the template DNA system. For example, 10-nm diameter gold beads covered with streptavidin can be allowed to bind to the biotinylated probes on the film under conditions that promote biotin-SA bonds. The unbound excess can then be washed-off. The film can be fixed, stained and the locations and orientation of the probe oligonucleotides can be determined by visualization of the SA gold beads under TEM.

The quality of the template DNA system, and the integrity of the process that generated the complementary copies, can determined by the location and geometric orientation of the “string of pearls” comprised of the 10 nm gold beads bound to each end of the probe oligonucleotides. Generally, a straight line of beads in the TEM will indicate a well-manufactured template suitable for further use as described below.

### Preparation of Platforms from ssDNA Template DNA Systems

The description below refers to the production of platform DNA systems from a gold-based ssDNA template. The platform DNA systems conceptually are a mirror image of the template DNA systems. These platforms can be either functionalized to perform desired tasks, or to serve as intermediates in the production of additional templates. The platform systems, which can be on a plastic or other robust substrate, may be more suitable for peptide manufacturing applications.

This example description of the platform DNA system follows the preparation of the exemplary template DNA system as described above, but uses a template DNA system that can be generated from a ssDNA library of 100 different ssDNAs, each having a unique, distinguishable, and non-redundant—however known—DNA base sequence. The lengths of the ssDNA strands can also vary from about 500 to about 10,500 nucleotides in length, with a minimal size difference of about 100 bases between the different ssDNA strands of the library. This library can be conveniently generated from public domain DNA plasmids and constructs or by any other suitable methods.

To prepare the template DNA, 100 different, master ssDNA strands ranging in size from 500 to 10,500 nucleotides long, can be added to modified gold TEM grids and stretched across a plastic surface as described above. A permanent template DNA system on-gold can then be generated as described above. A complete mirror image copy (100% complement) of the template, which is referred to as the “platform DNA system,” can be prepared as described below.

The ssDNA template system can be carefully cleaned and the solvation changed to one that promotes hybridization. 30 nt-long ssDNA oligonucleotides that comprise the entire complement of the template DNA system can then be added to the template system. After hybridization and washing, the solvation can be changed to one that preserves hybridization but which is appropriate to a high melting temperature and high-strength elastomeric material. The high melting temperature, high tensile strength elastomer preferably has the following properties: (i) when solidified, it forms a hydrophilic positive charge on its surface, (ii) is of low liquid viscosity and low unit liquid size (minimum drop size), and thus can fill-in gaps and holes smaller than 50 nm on a side, (iii) is quickly photo-polymerizable upon exposure to short wavelength ultraviolet light (254 nm wavelength=“UVC”), and (iv) does not distort from its molded, liquid shape when solidified (i.e., polymerized) to greater than 25 nm (maximum bleb size). Candidate elastomers that have these properties include dimethacrylate and diacrylate resins, polycaprolactones, and surface-modified polydimethyl- and polyvinyl-siloxanes. A thin (˜0.5 mm) layer of the high-melt/high-strength elastomer is allowed to flow onto the template DNA system hybridized with the entire complement of ssDNA oligonucleotides, and allowed to fill-in all the gaps between and encapsulate the strands. After UV photo-polymerization of the elastomer, a hard backing can be bonded to it via an adhesive. The hard backing can be another elastomer to serve as an even harder backing for insulation and handling of the first elastomer. Candidate hard backing elastomers include polyurethanes, polystyrenes, and polypropylenes. The adhesive preferably binds both hydrophilic and hydrophobic surfaces. The elastomer(s) can be further constructed on a substrate, such as a polyimide, ceramic, or glass. The platform can then be heated hot enough to denature the hybridization bonds between the template ssDNA and the ssDNA oligonucleotides on the solidified initial elastomer, and the platform DNA system can be carefully removed from the template.

Each platform DNA system generated as such from a template can then be used for either manufacturing, or to generate new templates. The latter would be accomplished by the same mirror-image hybridization as described above that utilizes a full-complement library of oligonucleotides that have been functionalized to be accepted to a subsequent material. In an exemplary case, a mutlipolymer-based platform is used to generate a gold-based template by hybridization of the platform with 30 nt a-S oligos that comprise the entire complement of the platform DNA system. The template ssDNA system would then be recreated by facilitating the binding of the a-S oligos to the gold surface in a manner that preserves the orientation of the oligos, reflective of (mirror mage to) the geometrical order of the platform, and, thus, exactly that of the original template ssDNA system. This strategy can result in an exponential production of similar templates from a relatively small number of originals.

If the master ssDNA was stretched and aligned on a grooved surface, a photo-polymerizable elastomer having an even smaller drop size and lower viscosity than the one described above can be used to fill-in the troughs in which the master ssDNA and hybridized compliment oligonucleotides are located. A photolithographed gold layer (atop a pre-lithographed layer of, for example, titanium) can be upwards of 50 nm in height, Thus, the polymer in its liquid state should be able to flow into and reach the 30 nt oligonucleotides at the bottom of each trough. In addition, since the elastomer is charged, with individual monomers likely having a high dipole moment, the elastomer may be strongly repulsed by the 12-carbon saturated alkanes of HDT that form high density “bristles” around each raised section. This is another reason why the elastomer in this case should flow and fill small volumes with ease. Depending on the thickness of elastomer necessary to accomplish these tasks, it is also desired that the elastomer absorb all UVC light used for polymerization else stray light reaching the hybridized master ssDNA and 30 nt oligos, and form undesired covalent bonds or otherwise damage the complement DNA.

As described above, each master DNA strand is preferably separated from its neighbor by approximately the diameter of a magnetic bead, e.g. 50 nm. In an example template system prepared as described above, TEMicroscopy suggested that approximately 100,000 DNA strands were on each template DNA system. Therefore, the size of a platform DNA system prepared from such a template DNA system was about 2000 nm or 2 microns wide, not counting peripheral areas, or “margins,” that lack DNA but are necessary for handling and manipulation.

Since both the length and the sequence of each member of the 100-mer library is known, knowledge of the identity of each strand on the platform can be determined by the use of probe oligonucleotides with 10-nm beads as described previously. Most importantly, the DNA base sequence of each 50×50 nm unit location or “address” on the platform can then be determined. As long as an ssDNA strand is straight, once the length is determined, the sequence at each point is known. Since the original master ssDNA library is composed of 100 different sequences, each of which is 100 bases shorter or longer than any other, the sequence at each point on the master is known by simply measuring the distance from the start of the strand (the modified gold TEM wall, “doormat” or “doorstop”) to the 50-nm magnetic bead, via QA of platforms generated from templates as described above. For example, assume a fictitious 100-mer library is indexed by length, with strand 1=500 nt in length, strand 2=600 nt . . . strand 100=10,400 nt in length. Using the QA method described above (“strings of pearls”), the platform can be generated from a template that was itself generated from a master that is composed of substantially straight (e.g., R squared value of 0.99 and above) and stretched ssDNA strands.

Once the strands have been shown to be straight, the identity of each strand on the platform can be QA determined in the following manner. A probe library of end-biotinylated, 50-mer oligonucleotides that are exact complements of the first and the last 50 nt of each master DNA strand and thus will bind to the first and last 50 nt of each platform strand can be hybridized to the platform, functionalized with 10-nm gold beads, and visualized using TEM as previously described. This procedure can reveal the identity of each strand via its extremities and define its length. Further verification of the identity of each strand can be done by using an additional probe oligonucleotides that bind to one or more 50 nt long sequences in the intervening sequence of each strand. Therefore, the DNA base sequence of each “address” on the platform DNA array can be determined.

In addition, if, for example, each member of the original master ssDNA library was 5′-thiolated, and 3′-biotinylated, the addresses determined as such would not only have the benefit of known nucleotide base sequences, but would also have a determined ssDNA polarity. Each defined address, for example if stretched 5′-to-3′ and left to right, would be the target of the site-specific localization of a probe oligonucleotide having the complementary sequence 3′-to-5′. The newly hybridized probe on the template system would also be stretched similarly to that of its complementary base address. Conceptually, if said probe oligonucleotide was functionalized with an electronic, electrochemical, optoelectronic, chemomechanical or any other conceivable device component requiring not only proper localization but also proper orientation for the proper functioning of the device, then the template ssDNA system so described would have the characteristics of what is commonly understood as a “high density addressable array.”

In one preferred embodiment of this aspect of this technology, the template ssDNA system would be composed of multiple polynucleotide strands wherein each 50 nm section would be comprised of a unique base sequence. Additionally, it is desired that the DNA sequence comprising each defined 50 nm address have a melting temperature manageably similar to that of other addresses to which it is desired that oligonucleotides complementary to those address sequences would hybridize simultaneously (and, thus, survive similar washing and other QA-related tests familiar to those practiced in the art). This enables the hierarchical placement of complementary oligonucleotides that have been functionalized, for example, with any combination of electro, optical, mechanical, and/or biological components as previously described, however in a manner such that the addressability of each component can be a function of hybridization stringency. An exemplary case would be the FAR RIGHT illustration above, wherein the stringency of hybridization of oligonucleotides to the cross-hatched quadrant was higher than in all other quadrants, with stringency of hybridization of probes to the high-density quadrant being only somewhat lower. A biological sensor having this template system as the main determinative device could be based on polymerase chain reaction (PCR)-mediated functionalization of biological toxins, blood products, microbial/virological agents, or any other applicable biochemical substance. Conceivable to those practiced in the art, PCR could be performed to detect such substances and “tag” them with an oligonucleotide complementary to those addresses in the cross-hatched pattern. If the detection scheme was designed in such a way that the “primary suspect” substances in the PCR were hierarchically amplified according to some criteria specific to, for example, pathogenicity or toxicity, then the PCR product associated with such substances could be similarly qualified in a hierarchical manner. In the exemplary case just described, substances matching the biosensor's profiling scheme would be tagged with oligos hybridizing to one or more of the (X) addresses (said probe oligos could also be further functionalized with electro-optical-bio-mems components as described). Secondary suspect molecules would be tagged with ( [symbol] )-addressing oligos, and so forth hierarchically to additional regions of the template system. Once functionalized to feedback regulatory systems that detected address specific hybridization, an art familiar to those practiced in molecular biology, micro-electromechanical systems, and other fields, the detection of the biological substance would become a reality, both in terms of quantification and degree of, for example, toxicity, due to measurement of the substance relative to other candidates and control molecules.

In another preferred embodiment of this aspect of this technology, the template ssDNA system would be composed of multiple polynucleotide strands wherein each 50 nm section would be comprised of a unique base sequence that was generated artificially. Given fact that naturally occurring DNA sequences have regions of base sequence homogeneity, repeats, imbalances (i.e., non 50%) in purine to pyrimidine ratios and other characteristics that do not define one linear portion, or “avenue,” of a well-ordered high density addressable array, it is preferred that each master ssDNA be artificially generated in whole or in part. Technologies such as artificial synthesis (for example by standard phosphoramidite chemistry on solid phase) of 50 nm-long oligonucleotides of defined sequence and desired melting temperature, sequentially hybridized to their complements and ligated together in a defined order, then PCR generation of multiple copies, can be undertaken to produce the double stranded DNA from which the master ssDNA is derived.

In another preferred embodiment of this aspect of this technology, the template ssDNA system would be composed of multiple polynucleotide strands wherein each 50 nm section would be comprised of a unique base sequence that was the foundation for construction of a singlet electro-optical-bio-mems component, or as the foundation for the addressing of multiple of such or different components that comprised a larger device. An aspect of SSTM that requires a high density addressable array for constructions in the nanotechnology area is the ability to manufacture each nanocomponent, specifically to functionalize it to a complementary oligonucleotide mated to a specific address or addresses on the template system. Exemplary components would be carbon nanotubes (for, e.g., electrical conductance), semiconducting polymers (for, e.g., information storage—electrically), porphyrin family of molecules (for, e.g., information storage—optically), cytochrome family molecules (for, e.g., information storage—biochemically), and other molecules and substances as needed. Such component molecules could be functionalized to probe oligos in a manner that hybridization localizes and orients the component in a manner that facilitates the proper functioning of a device, machine or larger system. One method in which to perform the oligonucleotide functionalization is add chemically-reactive groups at specific locations on the component. These reactive groups can be, for example, amines, acids, aldehydes, hydroxyls, thiols, epoxides, and halides. It is conceived that the location of one said group on a component, e.g., an amine, would correspond in locality to an aldehyde, acid or halide group on one terminus of a probe oligo, e.g., the 5′-end, to which it is to be functionalized. A dissimilar reactive group on the component would be located such that the desired chemical bond to the other terminus of the probe oligo, e.g., the 3′-end, would occur. The chemical bonds formed, 5′ and 3′, can be the same or different, can occur at the same or different times, and under the same or different conditions, so long as the resultant functionalization of the component facilitated it's localization to the correct address on the template system, and in the correct orientation relative to other components.

### Coupling of Amino Acids and the Preparation of Short Polypeptide Sequences from a DNA Template

The SSTM method described above can be used to create any one- or two-dimensional structure at nanoscale levels. SSTM functions analogously to the way living organisms produce proteins, and to the manner in which evolutionary pressures improve the activity and resilience of enzymes. However, SSTM dispenses with the messenger RNA step and synthesizes enzymes and other biologically active polymers directly from DNA. As described above, the template masters can be constructed from single strands of DNA which have been straightened with geometric regularity and permanently embedded upon a flat surface. Production templates or platforms, that facilitate the actual synthesis and are near perfect complementary copies of the original masters, can then be mass-produced.

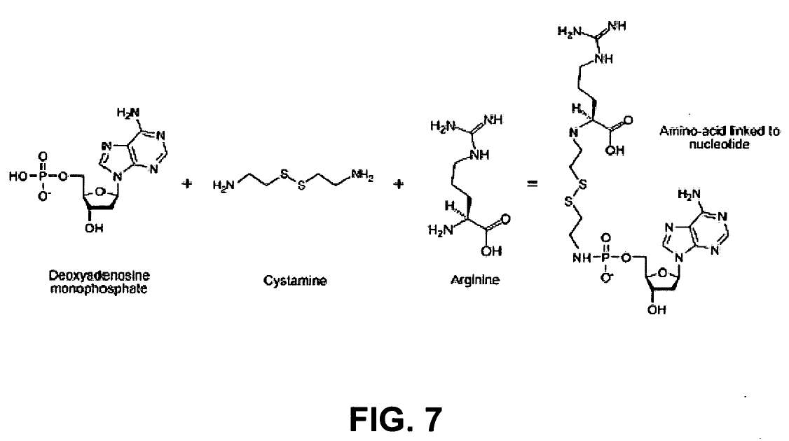

Amino acids can be coupled to DNA units (e.g., nucleotides) to form chimaeras that can be addressed to the template or platform DNA system to synthesize or assemble a polypeptide. For the purposes of making enzymes or other polypeptides, the amino acids can be coupled to nucleotides in a manner that preserves the biological activity of both. To form the chimaeras, the monophosphate versions of the four natural deoxynucleotide bases of DNA can be coupled to any natural or synthetic amino acid, via use of cystamine or other linking agents. For example, FIG. 7 shows the reaction of deoxyadenosine monophosphate with arginine via a cystamine linkage to provide a chimaera of the amino acid linked to the nucleotide.

A library of chimaeras comprising natural amino acids can be coupled to individual DNA units in the form of deoxynucleotidyl monophosphates (dNMPs). These dNMPs are referred to herein by their bases: dAMP, dTMP, dGMP and dCMP. Firstly, cystamine can be coupled to the 5′-phosphate groups of all four dNMPs using standard carbodiimide linking chemistry, using the molecules EDC and imidazole. Cystamine has a disulfide bond (—S—S—) in its middle and amines (—NH₂) on each end. The disulfide link can then be reduced to the free thiol (e.g., with 50 mM DTT). The resulting four intermediate products, comprising cystamine linked to the four dNMPs, can be purified via HPLC (e.g., per PIERCE tech Tip #30/Modify and label oligonucleotide 5′ phosphate groups). In the meantime, trityl-mercapto-ethylaldehyde (TMEA, molecular formula: Trt-S—CH₂—CH₂—COH, where Trt is a trityl protecting group residue) can be coupled to the N-terminal amines of each of the 19 of the 20 natural amino acids (except Proline) using standard sodium borohydride-based chemistry, using the molecule NaBH₃CN and others. The amino acids are referred to herein by their standard 3-letter designation, or (aa). TMEA is a coupling molecule, synthesized from available reagents, which has an aldehyde group (—CHO) on one end and a trityl-protected thiol group (—SH→—S-Trt) on the other. See S. Gzal et al., C. Gilon-1. Peptide Res. 58, 530 (2001), which is incorporated herein by reference. The resulting “secondary amino acids” can have their N-termini protected with the molecule Fmoc-Chloride via published techniques. Some protection of side chains may be necessary to prevent undesired side reactions via orthogonal chemistries familiar to those practiced in the art of SPPS. The (—S-Trt) end of the TMEA portion of each amino acid is then de-protected by reduction to the free thiol (—SH). HPLC purification and quantification can be performed between each synthesis step. Finally, each cystamine-coupled dNMP is mated to each MEA-coupled amino acid individually, resulting in a library of 76 different amino acid-dNMP molecules. These will hereinafter be referred to by their amino acid and nucleotide identities, e.g., MET-dCTP, with a linker group composed of residual cystamine and MEA implied, though not referred-to, in the acronym. In addition, monomers comprising other combinations of amino acids, nucleotides, and linker molecules (which may or may not be easily cleavable by standard methods), are herein also referred to as chimaeras.

Other chemistries can be used to bind the amino acids to the nucleotides to form the chimaeras. For example, ethylenediamine can be used to form a permanent (i.e., non-redox-cleavable) chimaera. Alternatively, the N′-terminus of the amino acid can be coupled to the carboxyl group of bromoacetic acid (the carboxyl group of the amino acid can be protected from undesired coupling, for example, by conversion beforehand to the methyl ester) wherein the bromine atom has undergone halide displacement to one end of cystamine. This results in an amide nitrogen on the amino acid, which cannot be further coupled, and a secondary amine on the linker molecule, which can be coupled. Alternatively, the polarity of the bromoacetic acid residue can be switched such that the N′-terminus of the amino acid has undergone halide displacement with bromoacetic acid and the carboxyl group of bromoacetic acid has been coupled to one end of cystamine. Further coupling will then occur only on the N′-terminus of the amino acid, which is now a secondary amine.

Depending on how the chimaera is formed, the nucleotide will be linked to cystamine first forming a phosphoramidite and the other end of cystamine, a primary amine group, will either be condensed directly to the N-terminus of an amino acid, undergo halide displacement with bromoacetic acid, or be coupled to bromoacetic acid and the amino acid linked subsequently. Since any primary or secondary amine group, electron rich nucleophile, or carboxylic acid, is susceptible to premature coupling, the relevant amino acids as well as the nucleotides having such groups can have those groups protected using orthogonal protection and deprotection schemes familiar to those practiced in the art of Solid Phase Peptide Synthesis (SPPS).

The presence of a carbonyl group, residual of bromoacetic acid, adjacent to the secondary amine of the monomeric chimaera helps to promote peptide bonding by the following mechanism. Whereas, the rate of HATU-mediated coupling has been shown to require up to 16 hours for N-acylated secondary amines, the dipole moment of the linker carbonyl (delta(+)carbon →delta(−)oxygen) attracts the C-terminus of the newly coupled amino acid residue, which has a similar carbonyl group as part of the amide bond. The attraction of unlike charges on the carbonyls facilitates translocation of the secondary amine carbonyl towards the C-terminus, which reduces range of motion of that carbonyl. Such a conformation “stiffens” the secondary amine and increases the chances of successful coupling. As inferred, HATU-mediated coupling of freely jointed secondary amines, is slowed by the ability of constantly-in-motion N-acyl side groups to inhibit covalent binding to activated C-termini by Van der Waals and other factors. As described, a reduction in range of motion and degrees of freedom of said N-acylated side groups—in the exemplary case a secondary amine “tail” comprising bromoacetic acid, cystamine or ethylenediamine, and a dNMP—will hasten the HATU-mediated coupling these and other similarly-engineered secondary amines, and by other amide bond-promoting catalysts.

Of note, Proline, an already-stiffened secondary amine, would be a distinct comparison momoner since it's N-acylation is based on cyclization to the alpha carbon, and naturally occurring versions are in the L-isomer orientation. Chimaeric molecules of the types described would not be limited by such chiralities, could be synthesized in either L- or D-isomers as desired, and coupling could occur either on the carbonyl-stiffened N′-terminus-alpha carbon-carboxyl terminus backbone, or on the secondary backbone as described above where the N-terminus on the chimaera is an amide and the secondary amine is on the linker group. Since it has been determined that (Pro) residues elicit “folding” behavior in primary structures of polypeptide chains, which result in well-defined secondary structures, e.g., “proline kinks,” the ability to design-in a number of different secondary amine groups provides the ability to control folding behavior of polypeptide and polypeptide-based polymers.

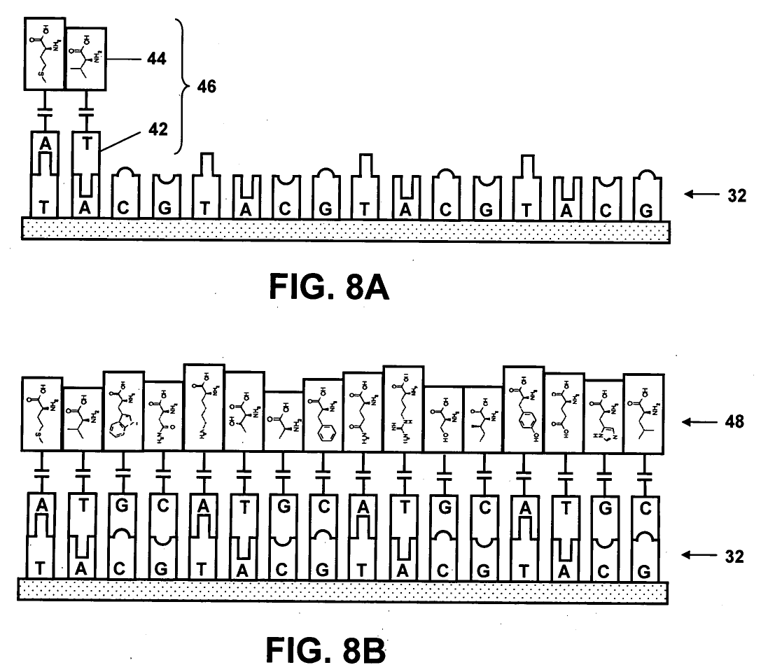

Returning to the synthesis specification, the resulting amino acid-nucleotide chimaeras are then addressed to the single strand DNA template in a manner consistent with Watson-Crick base pairing rules. Using chemistry common to SPPS, the amino acids can then be peptide-bonded to form either small peptides or to serve as the subunits of larger protein-based molecules. In case of the latter, the DNA nucleotide residues are preserved on the polymerized amino acid subunits, facilitating their addressability to other templates in a subunit sequence specific manner. When complete, the chimaeric molecules can be chemically treated to uncouple the polypeptide portion from their nucleotide carriers, leaving chains of amino-acids that, upon purification and qualification, are protein-based mimetic enzymes. FIG. 8A shows the basic concept of bonding of a chimaera 46 comprising an amino acid 44 and the DNA unit 42 to a template DNA strand 32 by nucleotide pairing. FIG. 8B shows a fully realized polypeptide sequence 48 as attached to the template DNA strand 32. One permanent single strand DNA master can exponentially generate a large number of single strand DNA production templates, which can then act as the foundation for synthesis of a wide variety of polymer molecules.

The ability of the single strand DNA template to correctly address both individual nucleotide-amino acid chimaeras, and larger assemblies of such, enable construction of a wide variety of protein-based polymers. As a result, polypeptide mimetics of high purity and of uniform amino acid sequence, molecular structure, size and biological activity can be achieved.

A particular spatial orientation can be forced on a polypeptide-based product in order to solve the folding problem prevalent within the construction of synthetic enzymes. In general, artificially manufactured polypeptides are limited in both their size and usefulness because of the lack of ability in the current art to elicit conformational shapes in peptides. A casual review of the literature and of manufacturers' catalogs reveal few if any peptides larger than 50 amino acid residues in length that guarantee biochemical and/or enzymatic activity. Though state of the art SPPS is more than able to produce polypeptides in excess of 50 residues in size, the ability to fold such polypeptides properly into active molecules remains problematic.

The three-dimensional structure of a given protein-based polymer can be controlled by selectively including or excluding the participation of a nucleotide and the molecules which serve as linking agents to the amino acid, i.e., cystamine and its derivatives. Standard amino acids can be used as monomers in synthesis if a three-dimensional structure prediction or determination has indicated it would be best to use them for protein folding (orthogonal protection, if necessary, is reasonably implied). Alternatively, bond-forming elements within the linking agents that bind to any combination of: (i) other linking agents, (ii) the reactive side chains of amino acid residues, and/or (iii) to a pre-formed solid surface or liquid-liquid interface, can be used to solve the folding problem. Residual molecules formerly linking amino acids to nucleotides can help manage the folding of polypeptide-based polymers into desired conformations, using molecular structures centered on the secondary amine “tails” that are artificially generated upon cleavage of the polypeptide-based product from its carrier nucleotides. For example, once the reduction-cleavable disulfide bond in the cystamine residue is severed, a polypeptide product is left with one or more secondary amine groups, that are distinct from the “natural backbone” N′-to-C′ of the product and that terminate in thiols, or mercaptyl, groups.

In the example process described herein, modifications to the standard amino acid monomers can provide polypeptides that have a large number of covalent links that form a secondary backbone, or “biomimetic skeleton,” and products having such a structure are heretofore referred to as mimetics. This additional structure is formed by the condensation of proximal thiol groups into disulfide bonds under conditions familiar to those skilled in the art, e.g., under oxidizing conditions. This additional structure on the polypeptide-based polymer can add resilience in excess of naturally-produced proteins having the same amino acid sequence. These improvements over standard biotic proteins enable enzymes and other polypeptide-based molecules to resist extremes of temperature, pressure, pH, salt and shear forces which characterize industrial processes and otherwise degrade the enzymes. Enzyme mimetics with preserved catalytic activity under trans-biotic conditions that would neutralize most naturally-occurring enzymes can be achieved. “Active Site Only” enzyme-like mimetics can be synthesized that do away with the mostly non-catalytic portion of the polypeptide and replace that with a stronger organic or inorganic scaffold. Further, the enzymes can be scaffolded, in whole or in part, to artificial surfaces. Therefore, functionalization of solid surfaces that facilitate enzyme-based industrial processes and biomedical components with long lasting catalytic protein mimetics can be achieved.

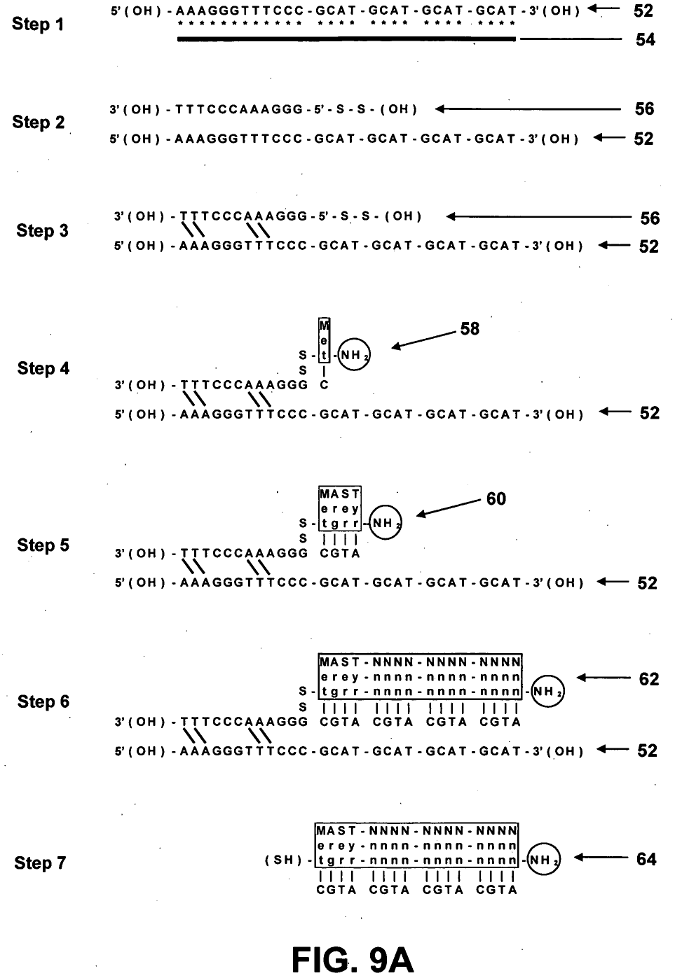

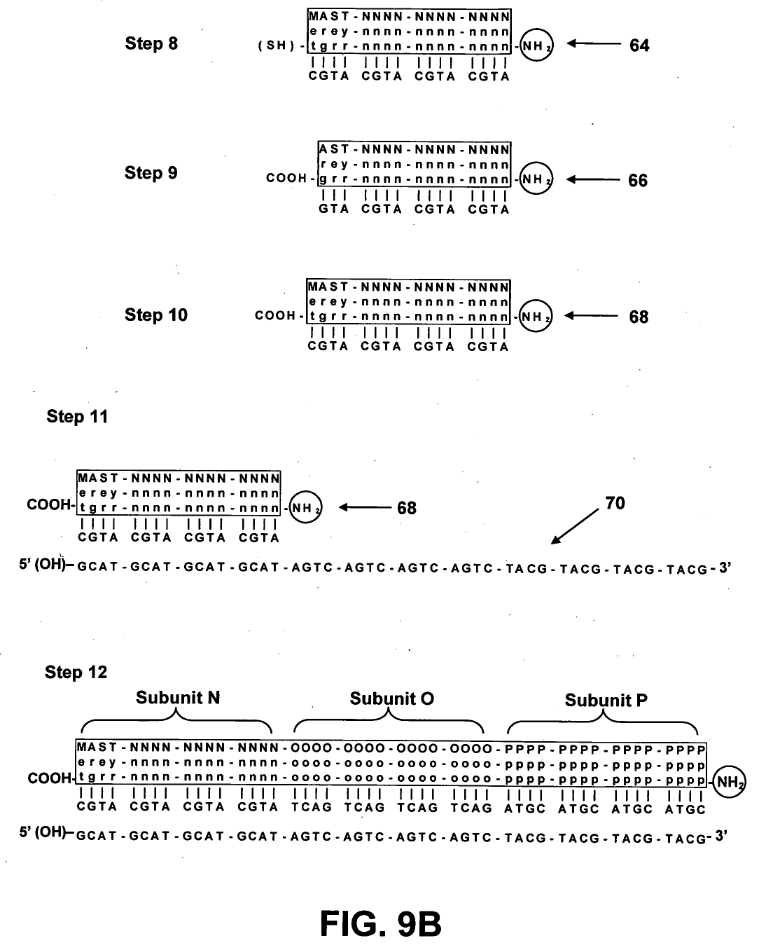

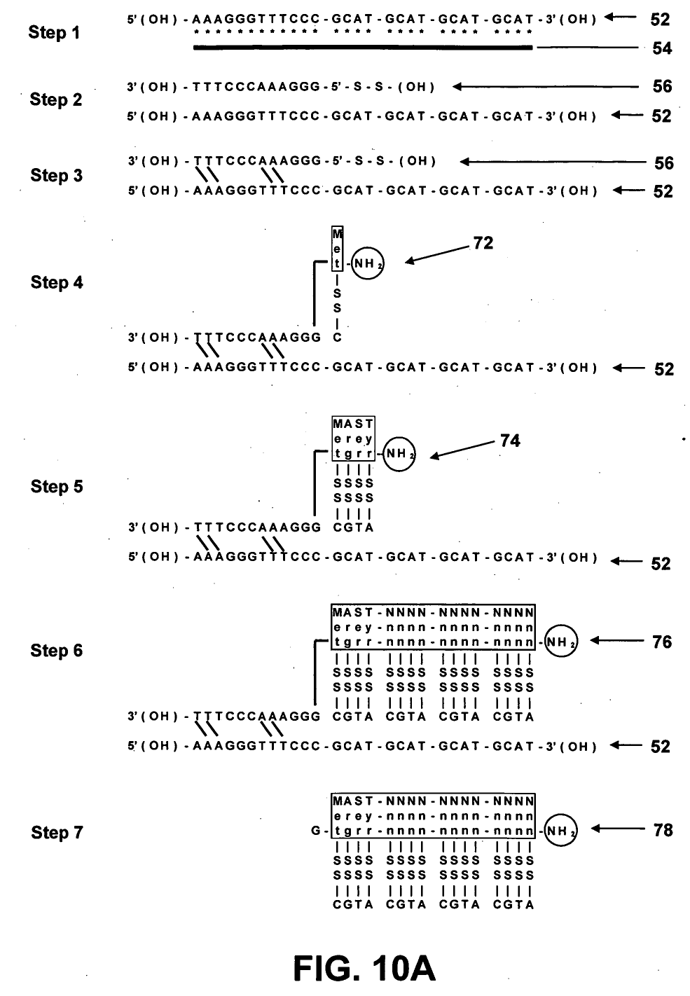

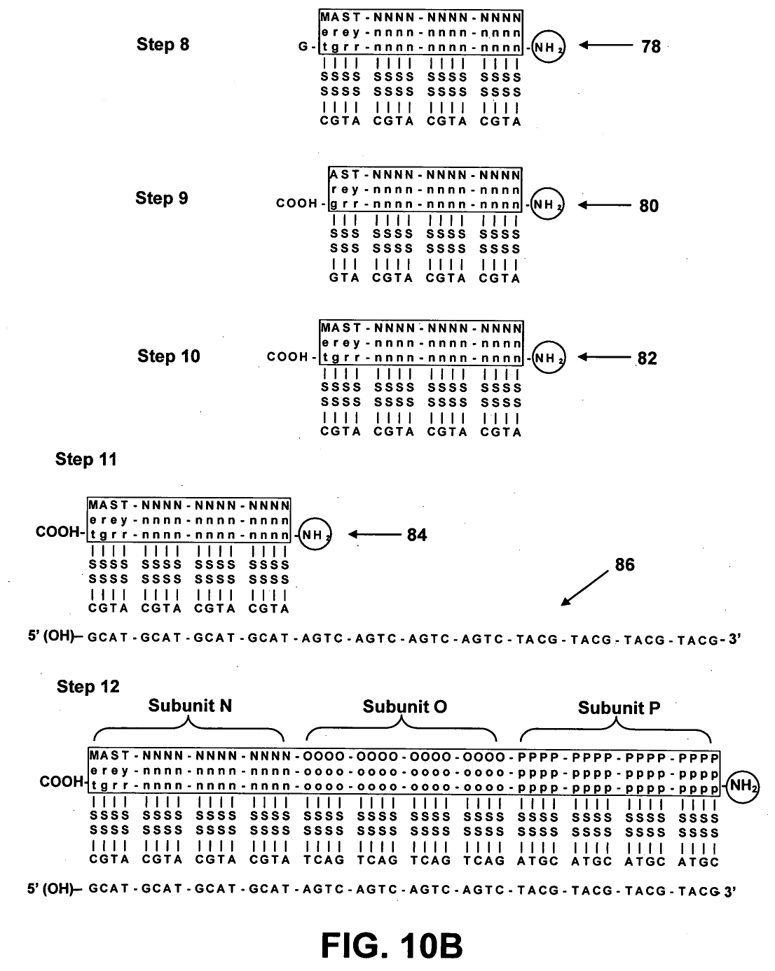

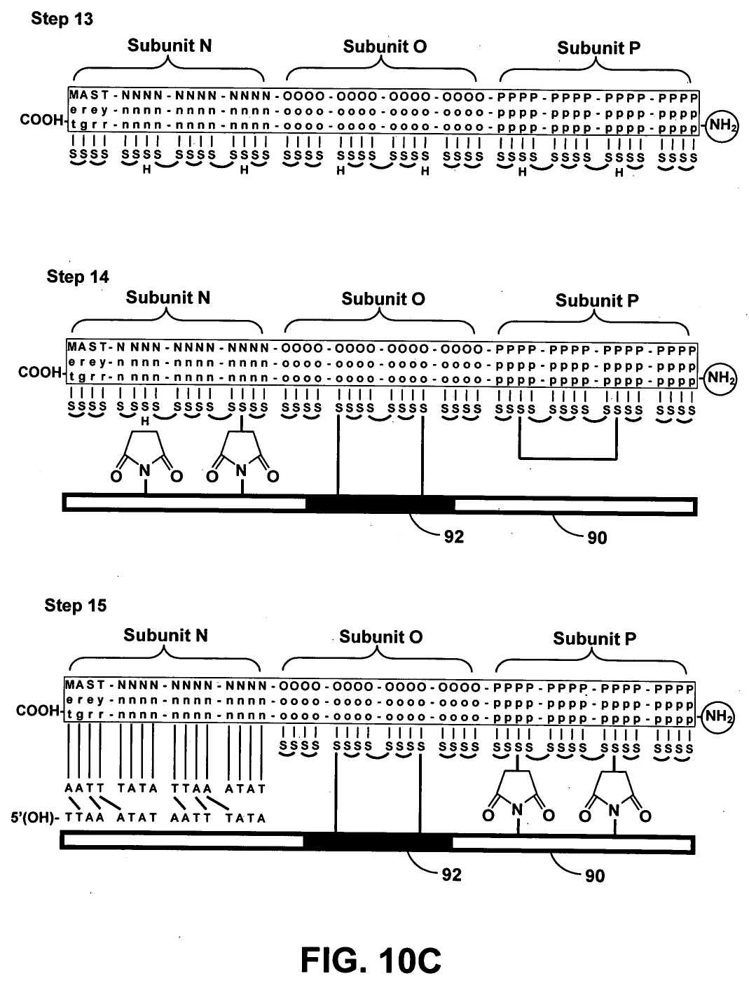

Below are described exemplary peptide syntheses that use ssDNA templates on-gold, amino acids coupled to DNA, a method of amidation (peptide bonding), and a method that will (1) significantly increase the structural strength of the polypeptide, and (2) allow the management and determination of the ultimate shape and conformation of the product. The description here corresponds in part to the methods shown in FIGS. 9A and 9B, and FIGS. 10A, 10B and 10C.

### EXAMPLE 1

### Fabrication of a ssDNA Template and Anchor Sequence

FIGS. 9A and 9B show an exemplary method (Steps 1-12) of synthesizing a polypeptide using a template DNA system, wherein the resultant polypeptide is covalently linked to its template DNA strand and can be a free polypeptide or can be complexed to a secondary skeleton via a scaffold with DNA binding capacity.

Step 1 shows a template DNA 52 bound to a gold surface 54 via (P)-thioate bonds (indicated by asterisks *). The template DNA 52 can be 5′-dephosphorylated to enable easier bonding to gold. The template DNA 52 in this example comprises a short 28 nt long a-S ssDNA sequence of unique sequence. The last 16 nt (counting from the 5′-to ‘3′ direction) will serve as the literal “template” from which amino acids will be addressed, and polypeptides produced.

The gold surface 54 can comprise any suitable gold surface, such as the flat gold surface described previously used to make a template DNA system. Alternatively, the surface 54 can comprise gold beads of approximately 30 nm in diameter. Such gold beads can be formed by prior art reduction of gold chloride (HAuCl₄-3H₂0) in citrate buffer. The resulting “colloidal gold” can then be precipitated with ethanol and resolvated to facilitate the binding of a template DNA. The gold beads can then be washed and standard testing (spectrophotometry that measures the amount of single strand DNA, and other methods) can then be performed to verify that the template DNA is on the gold beads. The persistence length of ssDNA in citrate buffer is such that the a-S oligonucleotides will bind straight and flat enough, backbone side down, for anchoring and templated synthesis to occur on the gold bead surface. As described above, other bead surfaces such as maleimide-coated and lithographically structured surfaces can also be used.

Step 2 shows a modified anchor DNA 56 added and allowed to hybridize to the template DNA 52. The 12 nt long ssDNA anchor sequence is complementary to the first 12 nt of the template DNA and is modified on one end to accept a first amino acid. As shown in this example, the 5′ end of the anchor DNA is functionalized with cystamine to present a free amine (—NH₂). This results in a cleavable disulfide bond and that coupled to the 5′-end of the anchor DNA using carbodiimide chemistry. The resulting anchor has a free amine on its 5′-end that is also cleavable under reducing conditions to de-couple the amino acids from the anchor.

At Step 3, after washing and determination that the anchor is properly on the template (e.g., via spectrophotometry that measures the amount of double strand DNA, and other methods), the solvation is changed to an environment preferential to the creation of inter-strand cross-links (indicated by \\) to covalently attach the anchor to the template. The molecule psoralen can be added to the gold beads with the template DNA and anchor DNA. Psoralen can form permanent covalent bonds between the anchor and template ssDNAs, upon proper solvation and dosing with UVA light (365 nm wavelength). After the solution is UVA-exposed, the psoralen is washed away. Standard testing can be performed to verify that covalent bonds have formed between the template and anchor ssDNAs (e.g., by heating and/or addition of denaturation chemicals that would otherwise separate non-covalently bound anchor DNA from the template DNA, and measurement of ssDNA and dsDNA concentrations by spectrophotometry).

The 16 nt-long “template” sequence in this example is comprised of four repetitions of the sequence G-C-A-T in the 5′-to-3′ direction. Amino acids are thus addressed to this unit sequence in the repeating order 3′-C-G-T-A-5′. Polypeptides of any reasonable length (e.g., from 64 to nearly 10,000 amino acids long) can be created by peptide bonding together 16 amino acid-long subunits, initially generated one amino acid at a time starting from the free amine group of the anchor sequence. Longer polypeptides can be created using DNA templates not on beads, but on a template-based system on a flat surface, as described above, which better facilitates the addressing of such subunits on more geometrically arrayed, i.e., straighter, ssDNA template strands.

After the preparatory Steps 1 to 3 above, the polypeptides can be synthesized according to the following Steps 4 to 12.

Step 4 shows the base-specific 5′-to-3′ addressing and amidation of the first coupled amino acid-nucleotide chimaera 58 (e.g., MET-dCMP) to the first template address (G1). This example uses ethylenediamine-coupled chimaeras. The coupled amino acid MET-dCMP can have its C′-terminus activated with the molecule HATU under solvation conditions that promote such activation, using familiar SPPS methods in which the monomer is pre-activated and added to the template. The MET-dCMP, with its HATU-activated C′-terminus, presents a protected N′-amine to prevent self-polymerization as shown by the encircled (—NH₂) group. The solvation of the template can then be changed to one that is both (i) compatible to the HATU-activation, and that also (ii) promotes hybridization of DNA bases. The activated MET-dCMP can then be added to the template beads and formation of a peptide bond between the MET-dCMP and the free amine on the 5′-end of the anchor sequence occurs readily. The excess monomeric chimaera can be washed-off and the template re-solvated to conditions compatible with deprotection. The Fmoc protecting group on MET-dCMP can then be removed by standard SPPS methods to allow the N-terminus to be converted back to its free amine for subsequent peptide bonding, for example with 20% piperidine in dimethylformmide (DMF). See A. R. Katritzky, K. Suzuki, and S. K. Singh—web′2004 p. 9, which is incorporated herein by reference.

Step 5 shows subsequent addressing and amidation of the second to the fourth amino acids (C′to N′): Arg, Ser, and Tyr, to the complements of their dNMP couples on the template (5′ to 3′) having locations: C1, A1, and T1. For example, the second DNA-amino acid, e.g., ARG-dGMP can be C-activated with HATU as above, added to the template as above, washed and its N-terminus deprotected from Fmoc. The third and fourth DNA-coupled amino acids, e.g., SER-dTMP and TYR-dAMP, can be added to the template and treated similarly. This four amino acid long polypeptide, still coupled to its DNA carriers (composed of four unique DNA bases) is referred to as a ‘packet’ 60, the smallest size polypeptide-based polymer of significance, and is a non-autonomous part of a subunit.

It is preferred to have the template sequence be comprised of tetranucleotide repeats, as shown, in order to maximize the distance between similar bases (i.e., all bases are separated by three dissimilar bases from themselves). This minimizes the chances of an addressed chimaeric molecule being coupled when not base-paired to the base directly 5′-adjacent to the growing polymer, e.g., MET-dCMP having first been coupled while addressed to location (G2), and not location (G1) as desired. Heretofore, a repeating tetranucleotide comprising a portion of the template, and which can comprise any single occurring combination of the bases A, T, G and C, is referred to as a “tetradon.” In this exemplary description, the first tetradon is 5′-G-C-A-T-3′. This term is chosen for comparison and distinction with “codon,” the commonly used term for a trinucleotide sequence. In general, a given codon will only code for one amino acid. A given tetradon sequence can code for (considering natural primary amine amino acids only, of which there are nineteen) 19 to the fourth power different amino acid sequences of packets, equal to 130,321 different combinations. This calculation (over ⅛ of one million different amino acid sequences for each packet alone) does not consider unnatural amino acids, other natural molecules having usable amine and carboxylic acid groups (and, thus, can serve as monomers), and synthetic chemicals having the same functionality. The possible sequence combinations of different packets are thus very large.

At Step 6, further addressing and amidation of the 5^{th to} 16^{th} amino acids (unspecified, designated N) forms an initial 16-amino acid-long subunit 62, referred to as Subunit N.

At Step 7, the subunit is delinked from the anchor at its C-terminus by reduction, presenting a free thiol group, and dehybridized from the template 52. The dehybridized subunit 64 is now autonomously addressable. In the example shown here, the couplings to dNMPs are not redox-cleavable.

Of note, the covalent nature of the anchor-to-template bonds, and that of the first amino acid (Methionine) to the 5′-end of the anchor, helps to keep the nascent polypeptide chain on the template and helps to promote hybridization of the DNA portion of the amino acid chimaeras onto the template DNA. This is important in consideration of the various solvations to which the nascent polypeptide chain must be exposed to in its synthesis, for example: (1) purely hybridization conditions (amine-free salt buffers promoting Watson-Crick type base pairing), followed by (2) HATU activation compatible hybridization conditions (in DMF, N-methylpyrolidone (NMP), and/or dimethylsulfoxide (DMSO), which are standard SPPS solvents), then (3) washing off of excess activated DNA-amino acids (in stringent organic and/or aqueous solvents), then (4) Fmoc deprotection conditions (e.g., 20% piperidine in DMF), and then back to either (1) or (2) again.

However, as seen at Step 8, because the first amino and the 5′-amine on the anchor were themselves bonded together via HATU activation (forming a strong peptide bond), the MET portion of the resulting polypeptide subunit 64 is complexed with an uncleavable cystamine residue on its C-terminus, i.e., a mercaptoethyl group (HS—CH₂—CH₂—N′-terminus of MET residue) even after reduction to cleave the subunit from the anchor. This amidated residue will prevent further peptide bonding and the creation of longer polypeptides. Thus, it will be necessary in all cases except for the first subunit (Subunit A) for the first amino acid of each subunit to be removed by deamidation in order to create a free carboxyl group for polymerization. This is accomplished by the following commercially available enzymes:
If the second amino acid (synthesized in the C-to-N direction) is LYS or ARG, the first amino acid can be removed by treatment with Carboxypeptidase B.
If the second amino acid (C-to-N) is anything other than LYS or ARG, the first amino acid can be removed by treatment with Carboxypeptidase A.

The remaining 15 amino acid-long sequence (for example, if this defines Subunit A, then their residue numbers on the final linear polypeptide-based polymer will be 2 through 15, counting from the C′ to the N′ direction) will now have a free C-terminus and the first amino acid in this subunit (number 1, Methionine) can be added back by (i) activation of the C-terminus of residue 2 (Arginine), and (ii) addition of a Methionine chimaera that has been N-terminus deprotected. This can be accomplished by either placing the 15 amino acid-long polypeptide back onto the template and repeating the activation/deprotection methods above, or in liquid phase solution. Subsequent subunits of a hypothetical 26 subunit-long polypeptide sequence (denoted Subunits A through Z) can be synthesized in a similar fashion. In all cases from Subunits B to Z, the first residue will need to be removed.

Step 9 shows the 15-mer subunit deletion fragment 66 after treatment with a carboxypeptidase to remove the first amino acid addressed to the subunit (Met) and present a free C′-terminus carboxyl group on the second amino acid (Arg).

Step 10 shows the 16-mer subunit 68 after HATU activation of the C′-terminus of Step 9 and re-amidation with Met. Alternatively, another amino acid can be used, and with another dNMP couple. In this example, both the original residue and the original nucleotide couple were preserved.

At Step 11, the intact subunit 68 is addressed to a longer template 70 (e.g., a gold foundation and a-S, or phosphorothioate bonds implied as in Step 1), via base-pair specific bonds. As shown in this example, this subunit represents “Part N” of a larger polypeptide that can be made up of an “alphabet” amount of subunits addressed on the template either behind (C′, implying a Subunit M not shown in the figure), or in front (N′, representing Subunits O, P, etc.) to this subunit.

Step 12 shows subsequent addressing and amidation of the O^{th} and P^{th} subunits in the C′-to-N′ direction on the template, to each other and to Subunit N. All subunits can be preactivated with HATU and added to one at a time to a pre-addressed subunit on the template that has been N-terminus deprotected. This pre-addressed subunit can optionally be “Subunit A” and still be disulfide bound to the anchor sequence, which promotes more efficient production due to the covalent bond of Subunit A to the anchor, which cannot be broken under the different solvation conditions, and variations thereof, as described above.

As shown in 70, the template DNA sequence comprises “quartets of tetradons,” i.e., subunits of 16-mer sequences comprising four repeats of the same tetradon. This design facilitates the correct addressing and orientation of each polypeptide-based polymer subunit to the template.

Upon completion of the polypeptide synthesis, if desired, the N′-terminus can be deprotected of Fmoc and the product complexed to a secondary skeleton via, in this example, a scaffold with DNA binding capability. Such an exemplary scaffold will comprise a two- or three-dimensional surface derivatized with nucleotides and/or bases that have been pre-formed into geometrical patterns. The patterns of such A,T,G, and C on the solid surface will facilitate the final three dimensional conformation, via folding, of the polypeptide product. If it is so desired, UV irradiation of the type that formed covalent bonds on the anchors, can be utilized to form stronger bonds between the polypeptide-based product and the nucleobases on the solid phase or scaffold.

### EXAMPLE 2

### Fabrication of a ssDNA Template and Anchor Sequence

FIG. 10A, FIG. 10B, and FIG. 10C together show another exemplary method (Steps 1-15) of synthesizing a polypeptide using a template DNA system, wherein the resultant polypeptide is covalently linked to its chimaeric nucleotide groups through cystamine linkages, which can be utilized to complex to a secondary backbone for scaffolding purposes.

Step 1 shows a 28-mer a-S ssDNA template 52 bound to a gold surface 54 (indicated by the thick line) via alpha-S, or phosphorothioate bonds (indicated by the asterisks *), as previously described.

Step 2 shows a 12-mer anchor 56 hybridized to the template 52. The anchor 56 is 5′-functionalized with ethylenediamine (H₂N—CH₂—CH₂—NH₂) phosphoramidated to the phosphate group of the 5′-Deoxyguanosine of the anchor) presenting a free amine (—NH₂).

Step 3 shows inter-strand cross-link covalent bonding of the anchor 56 to the template 52 via UV radiation.

Step 4 shows base-specific 5′-to-3′ addressing and amidation of the first amino acid Methionine, coupled via cystamine to its nucleotide carrier, forming the chimaeric molecule 72 (MET-dCMP), base-paired to the first template address (G1). Prior to addressing, (Met) was pre-activated on its C′-termini with HATU and presents a protected N′-amine.

Step 5 shows subsequent addressing and amidation of the second to the fourth amino acids (C′-to-N′): Agr, Ser, and Tyr, to the complements of their dNMP couples on the template (5′-to-3′): C1, A1, and T1. This results in a non-autonomous packet 74 of four amino acid residues.

Step 6 shows further addressing and amidation of the 5^{th} to 16^{th} amino acids (unspecified) to form a 16-amino acid long subunit 76.

At Step 7, the subunit is delinked from the anchor at its C′ via a DNA-depolymerizing nuclease, of which P1 Nuclease is an example, presenting the (G1) nucleotide still animated to (Met) and dehybridized from the template. The dehybridized subunit 78 is now autonomously addressable. In this example, the couplings to dNMPs are cleavable under highly reducing conditions.

At Step 8, also in this example the C′ (G) nucleotide is undesired and will be removed along with the first amino acid residue (Met).

Step 9 shows the 15-mer subunit deletion fragment 80 after treatment with a carboxypeptidase to remove the first amino acid addressed in the subunit (Met) and present a free C′-terminus carboxyl group on the second amino residue (Arg).

Step 10 shows the 16-mer subunit 82 after HATU activation of the C′-terminus of Step 9 and re-amidation with Met. Alternatively, another amino acid can be used, and with another dNMP couple. In this example, both the original residue and the original nucleotide couple were preserved.

Step 11 shows addressing of the intact subunit 84 to a longer template 86 (e.g., a gold foundation and (P)-thioate bonds implied as in Step 1), via base-pair specific bonds. As shown, this subunit represents “Part N” of a larger polypeptide made up of an “alphabet” amount of subunits comprised of subunits both C′ to (not shown) and N′ to (Subunits 0 and P) this subunit.

As with the previous example, the template comprises quartets of tetradons: 5′-(GCAT)₄-(AGTC)₄-(TACG)₄-3′, wherein each 16-mer subunit is assigned to a unique 16-mer quartet, via its nucleotide carriers, in order to correctly address each subunit to its correct location on the template, and also in the correct orientation.

Step 12 shows subsequent addressing and amidation of the O^{th} and P^{th} subunits in the C′-to-N′ direction on the template, and to Subunit N. All subunits can be pre-activated with HATU and added one at a time to a pre-addressed subunit on the template that has been N′-terminus deprotected. This deprotected subunit can optionally be “Subunit A” and still be ethylene diamine bound to the anchor sequence with the manufacturing benefits of such anchoring as previously described.

Step 13 shows a dehybridization from the template and a decoupling from its nucleotide carriers of the polypeptide product comprising Subunits N-O-P. Subsequent oxidation of the residual thiol tails that have been secondary-aminated to the N′-terminus of each amino acid results in the formation of disulfide bonds at random positions—on the average, one every two residues. As shown, a free thiol group remains from the formation of a disulfide bond between every three successive pairs of residues, i.e., a free (—SH) remains at approximately every 7^{th} former N-terminus. In this example, disulfide bond formation is largely random and driven by spatial proximity promoted by folding due to the side chains of the amino acids and the solvation conditions chosen that determine both folding as well as the kinetics of disulfide bond formation. For the present example, the exemplary product is simplified to a linear conformation (i.e., no folds) and one-in-seven free thiol groups, as shown.

Step 14 shows representative options in formation of secondary backbones formed by disulfide bonds, as well as functionalization of the free thiol groups for “scaffolding” purposes. Some or all of the residues can be scaffolded according to one of the three examples shown (thick=nanobar 90; solid black=gold 92). Extreme left example shows a maleimide group that has not yet bound to the free thiol in its proximity (shown for demonstration only). Second from left shows a maleimide-thiol bond. Middle two show direct binding of thiol groups to the gold portion of the nanobar. Right two show cyclization of the last two thiol groups on the N′-terminus of the polypeptide. The sum total of all such secondary functionalizations, to a secondary scaffold or not, determine the overall 3D conformation of the polypeptide.

Step 15 shows further options for backbone scaffolding. Subunit N residue shows base pair-specific addressing of the polypeptide to nucleobase moieties on the nanobar (UV-induced covalent bonds shown). Subunit P residue shows direct gold-to-thiol bonds. Subunit 0 residue shows maleimide-thiol bonds. As before, the shape of the secondary scaffold, base sequence and types of secondary amine tails affect the kinetics and direction of folding and, thus, determine the overall 3D shape.

### Performing Inverse Synthesis on ssDNA Templates

A variation on the aforementioned exemplary method of synthesizing polypeptide-based polymers from an ssDNA template involves the activation of carboxyl groups on the solid phase and the subsequent addressing of amino acid-nucleotide chimaeric monomers such that polymerization is achieved. This C-terminal activation can be accomplished by the following methods:

Method A. Activation of carboxyl groups (—COOH) and/or C-termini of amino acid residues in the solid phase by hydroxybenzotriazole-based activation agents (e.g., HATU) under organic solvation conditions, e.g., DMF, NMP, DMSO.

Method B. Activation of solid phase (—COOH) carboxyls by carbodiimide- or morpholinium-based activation agents (e.g., EDC, DMT-MM) under aqueous or alcohol solvation conditions, e.g., amine-free phosphate buffers like MES, or methanol.

Method C. Conversion of solid phase (—COOH) to acid chlorides (—COCl) by the use of thionyl chloride or phosphoryl chloride, under strictly organic solvation conditions, e.g., DCM. The general strategy for this involves the generation of a Vilsmeier-Haack intermediate via catalytic amounts of DMF, and also stabilization of the reaction through the presence of tertiary amines such as DIPEA and piperidine.

Method D. Conversion of the solid phase (—COOH) to anhydrides (—CO—O—OC—Ac) by the use of Acetyl Chloride under strictly organic solvation conditions, e.g., DCM, CCl4. The noted drawback of using carboxyl anhydride-based coupling is the stoichiometric loss of one half of the amine-based monomer to displacement of the Acetyl-acid group at each coupling step.

The main advantage of performing N-to-C direction synthesis on the ssDNA template system is that the need for N-terminal protection and deprotection is eliminated. Monomers of amino acids (all naturally occurring ones including Proline, and unnatural ones), similarly chimaeric molecules having secondary amine groups, or other molecules having amine groups (and acid groups if further polymerization is desired), can iteratively bind to activated ester carboxylic acids, acid halides or acid anhydrides on the template. Without the need for N-terminal protected amino acids, only orthogonally-protected side chain: (i) amine monomers (based on ARG, LYS, HIS or unnatural derivatives thereof), (ii) nucleophilic monomers (SER, TRP, TYR), and (iii) acids (ASP, GLU and derivatives) need be utilized in this form of inverse synthesis.

Another advantage of performing N-to-C direction synthesis is that activation of the solid phase, in contrast to activation of (—COOH) in the liquid phase, eliminates the possibility of C-terminal-activated monomers coupling to cyclic or exocyclic amines on the Adenosine, Guanosine and Cytidine moieties on the template (Thymine bases lack amines entirely), or self-polymerizing to themselves via their nucleotide carriers. The amines on nucleobases must be left unprotected so as to facilitate base pairing and addressing of monomers and subunits to ssDNA template systems.

### Consideration of the Liquid-Liquid Interface in Synthesis

Whether C-to-N or inverse (N-to-C) synthesis is performed, changes in system solvation need to be performed in order to accomplish multiple additions of monomers, activating agents, deprotection and washing steps. In most cases, even the least stringent solvents and buffers used for the above are not promoting of Watson-Crick type bare-pairings. In all cases, it is necessary to preserve the base-pairing between the ssDNA template and the steadily growing polypeptide-based product. Therefore, the length and chemical characteristics of the linker molecules connecting amino acids to their nucleotide carriers are designed such that they promote the formation of an interface. In the exemplary case described, the saturated alkane groups residual of cystamine and ethylenediamine help to support a hydrophobic interface (heretofore referred-to as the “mezzanine”) directly above the vicinal water-based solvent layer that normally saturates double-stranded DNA. Above this charged Debye layer of hydrogen-bonded nucleobases (A to T, C to G), water molecules, salts and other ions lies the deoxyribose groups of the carrier nucleotides linked to amino acids. These sugar groups are less hydrophilic than the bases, yet are not strictly hydrophobic (the sugar moieties of the template DNA do not contribute to this overall effect as they are not only phosphate-bonded 5′-to-3′-hydroxyl, but are also alpha-Sulfur bound to the gold surface). Thus, an ordered linear grouping of the chimaeric sugars forms, from bottom-to-top, a hydrophilic-to-hydrophobic mezzanine that separates the strictly “watery” layer below from, potentially, a strictly “organic” bulk phase above. In short, the aqueous layer that enables base pairings is protected from disturbance by the mezzanine, and by Van der Waals repulsion of organic solvents in the bulk phase away from the increasingly charged species (as one goes downwards). Thus, coupling reactions that include solvations in NMP, methanol and DCM, as described above, can still take place on a ssDNA template system without undue harm to the hydrogen bonds linking A to T and G to C. Needless-to-say, coupling reactions that take place under aqueous conditions, and that do not either dehydrate or deionize the aqueous layer, are preferred. However, organic-phase coupling reactions can still take place because they occur on—analogously—the “top floor” of the (from bottom to top) Au-a-S-deoxyribose-base::base-deoxyribose-alkane linker-amino acid structure. This distance is well into the bulk phase and far enough away from the “first floor” where base pairing has occurred, is buffered by a “mezzanine” of the deoxyribose groups of the chimaerics, and insulated by the hydrophobic “second floor” of saturated alkane groups of the linkers.

### Shaping and Strengthening of the Polypeptide Chain Via a Second Backbone

As implied above and shown in the example, different coupling molecules can be used in unique ways that result in polypeptide-based polymers with greatly enhanced structural strength and conformational “stiffness,” resistance to denaturation at extreme temperatures, hitherto novel conformational shapes, and functionalization to organic and inorganic “skeletal structures” to enhance the above improvements, etc.

Once the desired amino acid sequence is complete, the couplings to the DNAs can be broken by reducing conditions (e.g., with DTT or mercaptans), resulting in a chain of polypeptides that have residual cystamine groups secondarily-aminated to each amino acid residue. This would be the case if the amino acids in question were coupled to their nucleotide carriers with the molecules cystamine and 2-mercapto-ethylaldehyde.

If, however, the amino acids are coupled with the molecule Compound 6b+2, the couplings to nucleotides will remain intact, resulting in a chain of polypeptides that have residual DNA groups linked via an alkane linker. Compound 6b+2 is a coupling molecule, synthesized from available reagents, which has an aldehyde group on one end and a protected amine group (—NH2->—NH-Boc) on the other. See G. Bitan et al., C. Gilon-J. Chem. Soc., Perkin Trans 1, 1502 (1997), where n=5, which is incorporated herein by reference.

Variations of the above cases, i.e., some amino acids can be linked by cystamine plus 2-mercapto-ethylaldehyde, and some by Compound 6b+2, can be used with the intention of managing the ultimate conformation, shape, stiffness, skeletal-functionalization, and other aspects of the polypeptide product.

The following representative examples of the above noted improvements can be accomplished, and in the following ways:

a. A “linked chain” where each link is composed of two amino acids, can be constructed by oxidizing each two successive cystamine residues (denoted by C) on a polypeptide chain.

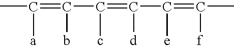

where (a-f) are the linkage points on a second skeleton (e.g., can be a thiol or maleimide group, or gold atom)
b. A stiff “second backbone” comprising sequential disulfide bonds, can be constructed by oxidation of each cystamine residue onto a conformationally-stiff alkene chain (skeleton), which has itself been modified to carry cystamine residues.
c. A conformation whence the middle of the polypeptide sequence has flexibility (wide range of motion and conformational options), and the extremities have a stiffened character (small range of motion and fewer conformational options), can be constructed by coupling of the middle amino acids with Compound 6b+2, and the amino acids on the extremities with cystamine plus 2-mercapto-ethylamine (with reduction), followed by oxidation to form disulfide bonds.

Other shapes and conformations can be achieved by mating the amino acids comprising the polypeptide chain to variations on these coupling molecules. It is only necessary to use a linker that has a free amine on one end and an aldehyde on the other, in order to couple this linker to, respectively, the 5′-phosphate of a DNA unit and the N-terminus of an amino acid. Such a linker, as explained, has the option of having a cleavable disulfide group.

As explained above, other types of linker molecules, with additional chemistries, can be used as linkers. Use of bromoacetic acid as an intermediate linker between the N-terminus of an amino acid (other than proline or its derivatives) adds further functionality and conformational options to the end-product. In the exemplary options described: (1) the amino acid can be N-acylated via halide displacement, forming a carboxyl-terminated secondary amine “tail” that can be amidated to either (i-a) cystamine or (i-b) ethylenediamine residues for the synthesis of chimaeras, to (ii) amine groups on amino acid residues (Lysine, Arginine, Histidine) to promote folding/conformation, and/or (iii) amine groups on solid surfaces; (2) the amino acid can be coupled to the carboxyl group of bromoacetic acid, forming a bromine-terminated secondary amide “tail” that can be further bonded to amines as just described.

Of significant note, the use of option (2) just described enables coupling, not on the natural backbone of the chimaeric molecule, but on the secondary backbone of the mimetic tail. Specifically, amidation of bromoacetic acid to the N-terminus of an amino acid has eliminated that location as a potential coupling point. However, upon halide displacement of the bromine atom and condensation to a free primary amine (such as that from cystamine or ethylenediamine), a secondary amine has been formed on the mimetic tail which, upon exposure to a HATU-activated carboxyl group on another monomer or polymer, will form a secondary backbone that is fused, at that location, via a peptide bond and not a disulfide bond as previously described.

Other halo acids can be used as linker components, and that include other halides, e.g., fluorine and iodine. The lengths of the halo acid backbones can range from ethanes to decanes, and can also be, in whole or in part, unsaturated, cyclic, and/or be further functionalized with chemically reactive groups.

Additional other chemistries are provided by commercially available molecules that, individually or in combinations, can serve thusly as: (1) linkers between amino acids and nucleotides, (2) portions of a secondary mimetic skeleton, and/or (3) braces for the attachment of the polypeptide-based polymer to a solid surface, i.e., a carapace. Examples of such chemistries can be hydrazides, keto-enol enabling groups, Sn2 reactions, imine formation and condensation of diols.

It is reasonably envisioned that, in addition to the functional groups on the linkers which enable different chemistries and options for attachment to other linkers or solid surfaces, the free energy-related behavior of the linkers will contribute to the folding of linear chains of subunits into final conformations. For example, cystamine and ethylenediamine largely comprise saturated alkanes as the “tails” that define secondary amines on chimaeric molecules. Available reagents enable the ability to utilize, for example: (i) linkers with saturated or unsaturated linear, branched and cyclic hydrocarbons, (ii) linkers with carbonyl groups (as with the use of bromoacetic acid in one case above), (iii) linkers with primary or secondary amine groups (as with the use of bromoacetic acid in another case above), and (iv) linkers with any combinations of keto, enol, aldehyde, epoxide, carbamate, and other groups. As long as the conditions are enabled for such linkers to bind N′-termini of amino acids to the 5′-phosphate groups of nucleotides, and preserve the addressing and coupling of such as described onto DNA templates, there is no reason why a wide variety of linkers cannot be used. Post-synthesis, the free energy minimizing behavior of these linkers can be taken into account in order to promote folding and desired product conformations. For example, if using a combination of generally hydrophobic linkers on one section of a polypeptide-based polymer, and generally hydrophilic (charged or high dipole moment) linkers on another section of the polymer, solvation of the polymer in aqueous media will result in a greater probability of the first section forming a hydrophobic core and the second section conforming to the outer periphery of the polymer. Solvation in anhydrous conditions will result in a reversed probability of the aforementioned conformation. Side chains of amino acids, hydrogen bonding of former C-terminal carbonyl oxygens to any protonated nucleophiles, and charge attraction/repulsion will, of course, also significantly contribute to the folding of linear polypeptide-based polymer chains and their ultimate conformation.

Additional variations on linkers that use the side groups of amino acids for inspiration can include hydrophobic groups (as in the side chains of ALA, ILE, LEU and VAL), hydrophobic groups that “stack” (as in the side groups of PHE and TYR), positively charged groups (as with ARG, LYS and HIS) and negatively charged groups (as with GLU and ASP). Such linkers can have actual amino acid-like side chains as functional groups, to promote product folding by, for example as inferred above, forming hydrophobic cores, stacked ring groups, salt bridges between acids and amines, and repelled conformations between similarly-charged groups, to either other linkers or the side chains of amino acid residues.

Yet additional variations can also be based on the Biotin-Streptavidin system, the Digoxigenin-Antibody-against-DIG system, sulfur groups (based on CYS or reduced and demethylated MET) binding to gold or maleimide-functionalized surfaces.

In summary, the molecular shape of the polypeptide, its conformation in different solvation conditions, resistance to denaturation under different extremes of temperature, pH, ionic strength, viscosity, etc., and even its ability to bind to a second skeleton can be predictably managed and achieved with the judicious use of linker molecules. These linker molecules initially served as couples to link amino acids to dNMPS for addressing to an ssDNA template—for faster and more efficient polypeptide synthesis. Afterwards, they serve as the basis for creating newer and better enzymes to catalyze a wide variety of chemical processes under conditions where naturally-synthesized enzymes, or even those manufactured using standard SPPS, would degrade and become unusable.

Having thus described in detail certain embodiments of the present invention, it is to be understood that the invention defined by the above paragraphs is not to be limited to particular details set forth in the above description as many apparent variations and equivalents thereof are possible without departing from the spirit or scope of the present invention.

I claim:

1) A template-based system for assembling a macromolecular structure comprising a surface comprising a plurality of single strand DNA molecules which are substantially parallel, substantially inline each from one end, and substantially equally spaced apart, wherein each DNA molecule has a distinguishable length and a known sequence.

2) The template-based system of claim 1, wherein the surface comprises gold.

3) The template-based system of claim 1, wherein the surface comprises plastic.

4) The template-based system of claim 4, wherein the single strand DNA molecules comprise a-Sulfur single strand DNA molecules.

5) The template-based system of claim 1, wherein the single strand DNA molecules comprise oligonucleotides.

6) The template-based system of claim 5, wherein the oligonucleotides comprise alpha-Sulfur oligonucleotides

7) The template-based system of claim 1, wherein the macromolecular structure assembled by the system is a polypeptide.

8) The template-based system of claim 1, wherein the macromolecular structure assembled by the system is a nanostructure.

9) The template-based system of claim 7, wherein the polypeptide is an enzyme.

10) The template-based system of claim 8, wherein the enzyme is a cellulase.

11) The template-based system of claim 7, wherein the polypeptide comprises a secondary skeleton.

12) A method for preparing a template-based system for assembling a macromolecular structure, comprising the steps of:
(a) providing a substrate having a surface and a doormat region,
(b) providing a plurality of single strand DNA molecules, each having a distinguishable length and a known sequence and each having a bead bound to one end and each bound at the other end to the doormat region, and
(c) stretching the plurality of single strand DNA molecules so that they are substantially parallel, substantially inline each from the doormat region end, and substantially equally spaced apart on the surface.

13) The method of claim 12, wherein the stretching comprises applying an electrical force acting on the negatively charged phosphate backbone of the DNA.

14) The method of claim 12, wherein the stretching comprises applying a magnetic force acting on the backbone and/or magnetic bead.

15) The method of claim 12, wherein the stretching comprises applying a centrifugal force acting on the bead.

16) The method of claim 12, wherein the single strand DNA molecules comprise a-Sulfur single strand DNA molecules.

17) The method of claim 16, further comprising bonding the alpha-Sulfur single strand DNA molecules to a gold surface to provide the template-based system.

18) The method of claim 12, further comprising hybridizing alpha-Sulfur oligonucleotides to their complement nucleotides of the single strand DNA molecules.

19) The method of claim 18, further comprising bonding the hybridized alpha-Sulfur oligonucleotides to a gold surface and releasing the bound alpha-Sulfur oligonucleotides from the single strand DNA molecules to provide the template-based system.

20) The method of claim 17, further comprising hybridizing oligonucleotides to their complement nucleotides of the alpha-Sulfur single strand DNA molecules, encapsulating the hybridized oligonucleotides with an elastomer, and releasing the hydridized nucleotides from the alpha-Sulfur oligonucleotides and the gold surface to provide a platform DNA system.

21) A method for assembling a macromolecular structure comprising the steps of:
(a) preparing a surface comprising a plurality of single strand DNA molecules which are substantially parallel, substantially inline each from one end, and substantially equally spaced apart, wherein each DNA molecule has a distinguishable length and a known sequence,
(b) sequentially addressing nucleotide-coupled amino acid chimaeras to complementary nucleotides of the single strand DNA molecules,
(c) forming covalent bonds between each adjacent amino acids to form the macromolecular structure, and
(d) disassociating the macromolecular structure from the coupled nucleotides.

22) The method of claim 21, wherein the macromolecular structure is a polypeptide.

23) The method of claim 22, wherein the polypeptide is an enzyme.

24) The method of claim 23, wherein the enzyme is a cellulase.

25) The method of claim 21, wherein each chimaera comprises an amino acid coupled to a deoxynucleotidyl monophosphate.

26) The method of claim 25, wherein the amino acid and the deoxynucleotidyl monophosphate are coupled by a cystamine linkage.

27) The method of claim 21, further comprising the step of attaching a secondary skeleton to the polypeptide via sulfur linkages at one or more amino acid residues.

28) The method of claim 27, wherein the secondary skeleton comprises one or more linkages selected from the group consisting of:
(a) thiol-maleimide linkages at one or more residues,
(b) thiol to gold linkages at one or more residues, and
(c) cyclized thiol linkages between two or more residues.

29) The method of claim 19, further comprising hybridizing oligonucleotides to their complement nucleotides of the alpha-Sulfur single strand DNA molecules, encapsulating the hybridized oligonucleotides with an elastomer, and releasing the hydridized nucleotides from the alpha-Sulfur oligonucleotides and the gold surface to provide a platform DNA system.
